(19) United States
(12) Patent Application Publication
(10) Pub. No.: US 2026/0072708 A1
(43) Pub. Date: Mar. 12, 2026

(54) Customizing Arrangements of Widgets in a User Interface

(71) Applicant: Sony Interactive Entertainment Inc., Tokyo (JP)

(72) Inventors: John Smith, Fallbrook, CA (US); Andrea Martinez, Brentwood, CA (US); Daniel Morales, Discovery Bay, CA (US); William Schupp, San Diego, CA (US); Derek Andrew Parker, Alameda, CA (US); Elisa Heiken, San Francisco, CA (US); Ludovic Douillet, San Mateo, CA (US)

(73) Assignee: Sony Interactive Entertainment Inc., Tokyo (JP)

(21) Appl. No.: 19/000,447

(22) Filed: Dec. 23, 2024

Related U.S. Application Data
(60) Provisional application No. 63/694,148, filed on Sep. 12, 2024.

(51) Int. Cl. G06F 9/451

(52) U.S. Cl. CPC G06F 9/451

(57) ABSTRACT

A computer system and method for presenting interactive graphical user interface (GUI) widgets are provided. Profile information associated with a user of the computer system is determined and a page is presented in a GUI. Based on the profile information associated with the user, a first template is determined that indicates a first arrangement of interactive GUI widgets to be presented in the page, whereby the first arrangement is different from that of a second template of a plurality of templates, each indicating an arrangement of a plurality of interactive GUI widgets. Based on the first template, the interactive GUI widgets are presented in the page arranged according to the first arrangement.

### CROSS-REFERENCES TO RELATED APPLICATIONS

This application claims benefit under 35 USC § 119 (e) to U.S. Provisional Patent Application No. 63/694,148 |filed Sep. 12, 2024, and entitled “Customizing Arrangements of Widgets in a User Interface,” the disclosure of which is incorporated by reference herein in its entirety for all purposes.

### BACKGROUND

Graphical user interfaces (GUIs) are the predominant type of interfaces available to users for interacting with computer systems. A GUI includes interactive widgets that surface real-time information from available computing services. The interactive widgets may be displayed within the GUI according to a predefined arrangement. In response to one or more inputs, a user may navigate within the GUI to a desired widget to view content from the underlying computing service. In response to further interaction with the desired widget, the underlying computing service may be executed to present additional content from the computing service.

### BRIEF SUMMARY

Embodiments of the present disclosure relate to techniques for better content generation and navigation in a graphical user interface (GUI). In some embodiments, a method implemented by a computer system is provided. The method may include determining profile information associated with a user of the computer system. The method may further include presenting a page in a graphical user interface (GUI). The method may further include determining, based on the profile information, a first template that indicates a first arrangement of interactive GUI widgets to be presented in the page, the first arrangement being different from that of a second template of a plurality of templates, each indicating an arrangement of a plurality of interactive GUI widgets. The method may further include presenting, based on the first template, the interactive GUI widgets in the page arranged according to the first arrangement.

In some embodiments, the profile information comprises one or more interests of the user determined from one or more account settings for an account associated with the user. In some embodiments, the profile information comprises one or more interests of the user determined from historical interactions by the user with content related to each of the one or more interests.

In some embodiments, the page comprises a first portion that is immediately visible upon presenting the page and a second portion that becomes visible in response to navigation inputs, and determining the first template comprises determining that a subset of the interactive GUI widgets that will be presented in the first portion based on the first arrangement are relevant to the profile information associated with the user.

In some embodiments, the page comprises a plurality of display positions in a structured layout and the first arrangement defines a display position and a presentation state within the structured layout for each of the interactive GUI widgets. In some embodiments, each of the plurality of display positions has a uniform size within the structured layout and the display position and the presentation state for an interactive GUI widget defines a starting display position within the structured layout and a number of display positions occupied by the interactive GUI widget within the structured layout.

In some embodiments, determining the first template comprises selecting the first template from the plurality of templates based on a relevance of the first template to the profile information associated with the user. In some embodiments, determining the first template comprises determining a relevance of each of the interactive GUI widgets to the profile information associated with the user and determining, based on the relevance of each of the interactive GUI widgets, an order of presenting the interactive GUI widgets within the page. In some embodiments, presenting the interactive GUI widgets according to the first arrangement comprises presenting the interactive GUI widgets in the determined order. In some embodiments, the page comprises a first portion that is immediately visible upon presenting the page, and determining the first template further comprises determining a display position and a display size for each of a subset of the interactive GUI widgets that will be displayed in the first portion of the page based on a size of the first portion.

In some embodiments, the interactive GUI widgets indicated by the first arrangement include a first subset of the plurality of interactive GUI widgets, the first subset being different from that of the second template. In some embodiments, the interactive GUI widgets indicated by the first arrangement are the same as that of the second template and a first order of presenting the interactive GUI widgets according to the first arrangement is different from that of the second template. In some embodiments, the interactive GUI widgets indicated by the first arrangement are the same as that of the second template and a size of presenting at least one of the interactive GUI widgets according to the first arrangement is different from that of the second template.

In some embodiments, the method further includes: receiving a request to review the plurality of templates; presenting, while the interactive GUI widgets remain visible in the page, a template menu comprising the first template, the plurality of templates, and an indication that the first template is currently selected; receiving, via the template menu, an interaction with the second template; and presenting, while the template menu remains visible, the interactive GUI widgets in the page according to a second arrangement of the second template.

In some embodiments, the profile information comprises a geographic location associated with the computer system and determining the first template is further based on the geographic location.

In some embodiments, the method further includes: receiving, via the GUI, a modification to the first arrangement indicated by the first template, resulting in a new arrangement of the interactive GUI widgets within the page; creating a new template with the new arrangement based on the modification; and storing the new template as a custom template with the plurality of templates. The method may further include: receiving, via the GUI, a subsequent modification to the new arrangement, resulting in a further modified arrangement; and updating the new template with the further modified arrangement in response to receiving the subsequent modification. The method may further include: receiving, via the GUI, a request to present the interactive GUI widgets in the page according to a different arrangement of a different template of the plurality of templates; presenting the interactive GUI widgets in the page arranged according to the different template; receiving, via the GUI, a subsequent modification to the different arrangement, resulting in a subsequent arrangement; and updating the new template with the subsequent arrangement in response to receiving the subsequent modification.

In some embodiments, the method further includes: receiving a notification comprising information about a new computing service available to the computer system; displaying a temporary interactive GUI widget at a beginning of the first arrangement in the page, the temporary interactive GUI widget including the information about the new computing service; and removing, in response to an interaction with the temporary interactive GUI widget, the temporary interactive GUI widget from the first arrangement.

In some embodiments, a computer system is provided. The computer system may comprise one or more processors and one or more memories storing computer-readable instructions. Upon execution by the one or more processors, the computer-readable instructions may configure the computer system to determine profile information associated with a user of the computer system. The computer system may be further configured to present a page in a graphical user interface (GUI). The computer system may be further configured to determine, based on the profile information, a first template that indicates a first arrangement of interactive GUI widgets to be presented in the page, the first arrangement being different from that of a second template of a plurality of templates, each indicating an arrangement of a plurality of interactive GUI widgets. The computer system may be further configured to present, based on the first template, the interactive GUI widgets in the page arranged according to the first arrangement.

In some embodiments, one or more non-transitory computer-readable media are provided. The computer-readable media may store computer-readable instructions that, upon execution on a computer system, cause the computer system to perform operations comprising determining profile information associated with a user of the computer system. The operations may further comprise presenting a page in a graphical user interface (GUI). The operations may further comprise determining, based on the profile information, a first template that indicates a first arrangement of interactive GUI widgets to be presented in the page, the first arrangement being different from that of a second template of a plurality of templates, each indicating an arrangement of a plurality of interactive GUI widgets. The operations may further comprise presenting, based on the first template, the interactive GUI widgets in the page arranged according to the first arrangement.

In some embodiments, a method implemented by a computer system is provided. The method may include presenting, based on a first template, an arrangement of interactive graphical user interface (GUI) widgets in a page. The method may further include presenting, in response to a request to edit the arrangement, and while the arrangement in the page remains visible, a set of editing controls each corresponding to an interactive GUI widget of the interactive GUI widgets, the set comprising a first editing control corresponding to a first interactive GUI widget. The method may further include presenting, in response to an interaction with the first editing control, and while the page continues to be presented, a modification to the first interactive GUI widget in the arrangement according to the interaction with the first editing control.

In some embodiments, each editing control comprises one or more selectable options for modifying a display of the corresponding interactive GUI widget. In some embodiments, each interactive GUI widget is associated with a corresponding service provided by the computer system and each editing control of the set of editing controls includes an indication of the service of the corresponding interactive GUI widget.

In some embodiments, the arrangement indicates an order of presenting the interactive GUI widgets in the page. In some embodiments, the interaction with the first editing control comprises a selection of an option to remove the first interactive GUI widget from the arrangement and presenting the modification comprises removing the first interactive GUI widget from the page. In some embodiments, presenting the modification further comprises shifting a subset of the interactive GUI widgets that were lower in the order than the first interactive GUI widget into a higher display position within the order. In some embodiments, the set of editing controls are presented according to the order of presenting the interactive GUI widgets, and the method further comprises presenting the first editing control at an end of the set of editing controls in response to the selection of the option to remove the first interactive GUI widget from the arrangement.

In some embodiments, the interaction with the first editing control comprises a selection of an option to add the first interactive GUI widget to the arrangement of interactive GUI widgets in the page and presenting the modification comprises adding the first interactive GUI widget to an end of the order of presenting the interactive GUI widgets. In some embodiments, the interaction with the first editing control comprises a selection of an option to add the first interactive GUI widget to the arrangement of interactive GUI widgets in the page and presenting the modification comprises adding the first interactive GUI widget at a first position within the order of presenting the interactive GUI widgets and shifting a subset of interactive GUI widgets down within the order. In some embodiments, the interaction with the first editing control comprises a selection of an option to move the first interactive GUI widget to a new position within the order of presenting the interactive GUI widgets and presenting the modification comprises displaying the first interactive GUI widget at the new position within the order and shifting a subset of the interactive GUI widgets that are lower in the order than the new position. In some embodiments, the interaction with the first editing control comprises a selection of an option to resize the first interactive GUI widget from the arrangement and presenting the modification comprises increasing or decreasing a display size of the first interactive GUI widget within the arrangement.

In some embodiments, the interaction is a selection of the first editing control from the set of editing controls and presenting the modification comprises emphasizing the first interactive GUI widget relative to other interactive GUI widgets in the page. In some embodiments, emphasizing the first interactive GUI widget comprises changing a display opacity of the first interactive GUI widget relative to display opacities of the other interactive GUI widgets in the page.

In some embodiments, presenting the modification to the first interactive GUI widget results in a new arrangement of the interactive GUI widgets in the page and the method further comprises: creating, in further response to the interaction with the first editing control, a new template with the new arrangement based on the modification; and storing the new template as a custom template with a plurality of templates including the first template.

In some embodiments, the arrangement is different from that of a second template of a plurality of templates, and the method further comprises: presenting, in response to a request to review the plurality of templates, and while the page continues to be presented, a template menu comprising the first template, the plurality of templates, and an indication that the first template is currently selected; receiving, via the template menu, an interaction with a second template from the plurality of templates; and presenting, while the template menu remains visible, the interactive GUI widgets in the page according to a second arrangement of the second template.

In some embodiments, a computer system is provided. The computer system may comprise: one or more processors; and one or more memories storing computer-readable instructions. Upon execution by the one or more processors, the computer-readable instructions may configure the computer system to present, based on a first template, an arrangement of interactive graphical user interface (GUI) widgets in a page. The computer system may be further configured to present, in response to a request to edit the arrangement, and while the arrangement in the page remains visible, a set of editing controls each corresponding to an interactive GUI widget of the interactive GUI widgets, the set comprising a first editing control corresponding to a first interactive GUI widget. The computer system may be further configured to present, in response to an interaction with the first editing control, and while the page continues to be presented, a modification to the first interactive GUI widget in the arrangement according to the interaction with the first editing control.

In some embodiments, the arrangement indicates an order of presenting the interactive GUI widgets in the page. In some embodiments, the interaction with the first editing control comprises a selection of an option to remove the first interactive GUI widget from the arrangement. In some embodiments, presenting the modification comprises: removing the first interactive GUI widget from the page; and shifting a subset of the interactive GUI widgets that were lower in the order than the first interactive GUI widget into a higher display position within the order. In some embodiments, the set of editing controls are presented according to the order of presenting the interactive GUI widgets, and the computer system is further configured to present the first editing control at an end of the set of editing controls in response to the selection of the option to remove the first interactive GUI widget from the arrangement.

In some embodiments, the interaction with the first editing control comprises a selection of an option to add the first interactive GUI widget to the arrangement of interactive GUI widgets in the page, and presenting the modification comprises adding the first interactive GUI widget at a first position within the order of presenting the interactive GUI widgets and shifting a subset of interactive GUI widgets down within the order.

In some embodiments, one or more non-transitory computer-readable media storing computer-readable instructions are provided. Upon execution on a computer system, the computer-readable instructions may cause the computer system to perform operations comprising presenting, based on a first template, an arrangement of interactive graphical user interface (GUI) widgets in a page. The operations may further comprise presenting, in response to a request to edit the arrangement, and while the arrangement in the page remains visible, a set of editing controls each corresponding to an interactive GUI widget of the interactive GUI widgets, the set comprising a first editing control corresponding to a first interactive GUI widget. The operations may further comprise presenting, in response to an interaction with the first editing control, and while the page continues to be presented, a modification to the first interactive GUI widget in the arrangement according to the interaction with the first editing control.

### BRIEF DESCRIPTION OF THE DRAWINGS

FIG. 1 illustrates a computer system that presents a dashboard, according to an embodiment of the present disclosure.

FIG. 2 illustrates an example of a dashboard presenting multiple widgets, according to embodiments of the present disclosure.

FIG. 3 illustrates an example of a computer system that presents a dashboard populated with widgets, according to embodiments of the present disclosure.

FIG. 4 illustrates an example of a display that presents a dashboard including widgets, according to embodiments of the present disclosure.

FIG. 5 illustrates an example of a display presenting a dashboard in response to an interaction with a dashboard template menu, according to embodiments of the present disclosure.

FIG. 6 illustrates an example of a display presenting a dashboard in response to an interaction with a widget menu, according to embodiments of the present disclosure.

FIG. 7 illustrates an example of a display presenting a dashboard in response to an interaction with a widget editing control, according to embodiments of the present disclosure.

FIG. 8 illustrates another example of a display presenting a dashboard in response to an interaction with a widget menu, according to embodiments of the present disclosure.

FIG. 9 illustrates another example of a display presenting a dashboard in response to an interaction with a widget editing control, according to embodiments of the present disclosure.

FIG. 10 illustrates an example of a display presenting a dashboard in response to an interaction with a widget relocation control, according to embodiments of the present disclosure.

FIG. 11 illustrates an example of a display presenting a dashboard in response to an interaction with a widget presentation state control, according to embodiments of the present disclosure.

FIG. 12 illustrates an example of a display presenting a developer widget menu, according to embodiments of the present disclosure.

FIG. 13 illustrates an example flow for presenting widgets in a page, according to embodiments of the present disclosure.

FIG. 14 illustrates an example flow for editing an arrangement of widgets in a dashboard, according to embodiments of the present disclosure.

FIG. 15 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Generally, systems and methods for improving the display of widgets in a graphical user interface (GUI) are described. Typically, widgets are displayed in a GUI in accordance with a predefined template that dictates their arrangement, order, and/or size, as well as a starting point for navigating through the widgets. In certain situations, widgets that are placed earlier in the order, or that are displayed more prominently, do not correspond to a user's current or general interests. In such cases, the user may end up navigating past a number of widgets to view a desired widget. Repeated navigation to desired widgets may result in unnecessary resource consumption by the computer system, decreased engagement with new computing services that may be surface through widgets, and a diminished user experience.

Hence, although a GUI can be an effective user interface to surface relevant information from available computing services, there is a need for an improved GUI that takes a user's interests into account, enables subsequent customization, and provides intuitive and streamlined navigation through the native interface. To illustrate, consider an example of a video game system. The video game system can host a menu application and a dashboard application. The dashboard application can generate a plurality of widgets for display within a page provided by the menu application. The widgets may correspond to various applications and services available on the video game system. A video game player can login to the video game system.

Upon a user button push on a video game controller, a menu can be presented and can include different tiles. Each tile corresponds to an application or service. To view content or other information from a particular application or service, the user can navigate through the menu to the tile corresponding to the particular application or service and select the tile to launch the application or service. The video game system may then execute the application and/or service, or otherwise transfer control over the GUI to the application. The user may then navigate within the GUI provided by the application and/or service to view the desired content or other information.

To reduce the redundancy of menu presentation, and additional processing associated with navigating through the menu and launching individual applications and/or service, the menu application may provide a dashboard interface or page to surface a collection of relevant content and information from various applications and/or services to the user. The dashboard application may populate the dashboard with a plurality of widgets. Each widget may display content and/or other information from an underlying application or service. The plurality of widgets may be displayed according to one of a number of predefined arrangements or templates. Each arrangement may be predefined to align with possible interests of the user. The dashboard application may determine the interests of the user from one or more account settings and/or historical interactions with content. The dashboard application may select the predefined arrangement of widgets that corresponds to the interest of the user and present the widgets in the page provided by the menu application.

To further reduce the redundancy of navigating within the page of widgets, the dashboard application may provide one or more interfaces and/or options for switching between predefined templates, editing predefined templates, and creating new templates. The dashboard application may cause the one or more interfaces and/or options concurrently with the display of the widgets in the page. In response to an interaction by the user with an interface or option, the dashboard application may cause the display of widgets in the page to be updated accordingly.

Embodiments of the present disclosure provide several advantages over existing GUIs and their underlying computer systems. For example, a page of widgets according to a predefined template arrangement that aligns with a user's interests streamlines navigation within the page of widgets. In particular, menu redundancy is reduced by presenting UI elements that otherwise would have necessitated additional navigation by the user in a portion of the page that is immediately visible to the user. Concurrently displaying options for modifying the display of widgets, as well as their modifications, further streamlines navigation and reduces menu redundancy by eliminating the need for a user to navigate to a separate settings page to make changes to the arrangement of widgets and then navigate back to the page to view the effect of the changes. Such improvements may reduce system computational demands arising from the need to otherwise navigate large menus with a large number of icons, and may improve user experience by reducing frustration and fatigue caused by inefficient menu navigation.

In the interest of clarity of explanation, the embodiments may be described in connection with a video game system including a video game console. However, the embodiments are not limited as such and similarly apply to any other type of a computer system. Generally, a computer system presents a dashboard in a GUI on a display. The dashboard presents UI elements, each corresponding to an application, service, or collection of information.

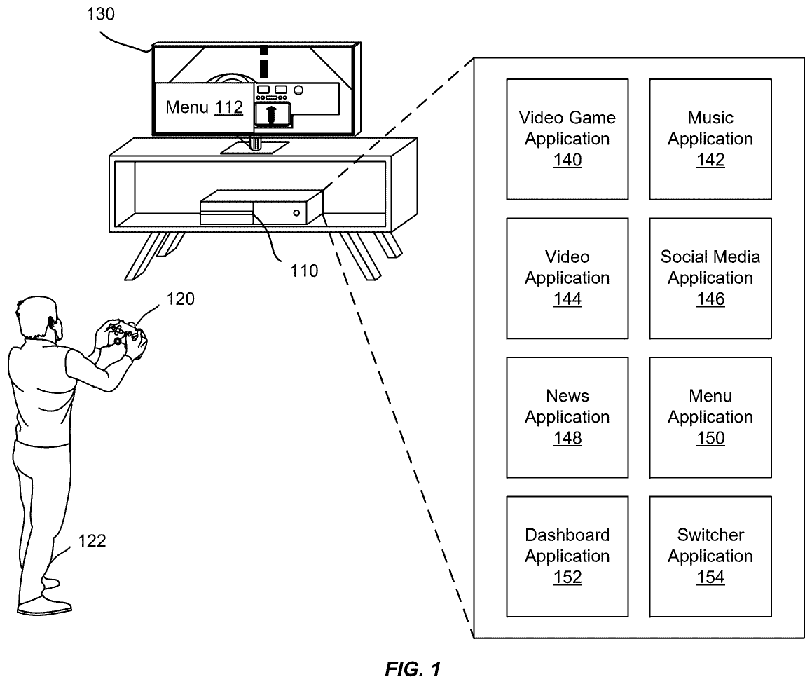

FIG. 1 illustrates a computer system that presents a dashboard, according to an embodiment of the present disclosure. As illustrated, the computer system includes a video game console 110, a video game controller 120, and a display 130. Although not shown, the computer system may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). A video game player 122 operates the video game controller 120 to interact with the video game console 110. These interactions may include playing a video game presented on the display 130, interacting with a dashboard 112 presented on the display 130, and interacting with other applications of the video game console 110 (e.g., with media applications to stream media from an online content source or to play a media file from the local storage of the video game console 110).

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented form local storage of the video game console 110. Further, other applications can be likewise included in the video game console 110, such as a chat application. The availability of a video game application, media application, and/or other type of computer application to the video game player 122 via the video game console 110 can depend on a user identifier of the video game player 122 (e.g., upon a login to the video game console 110, the availability of the computer applications can depend on the user identifier used in the login). In addition, the video game console 110 includes a menu application 150, a dashboard application 152, and a switcher application 154. The menu application 150 can present a home user interface (UI) in a GUI of the display 130. The dashboard application 152 can present an arrangement of interactive UI widgets in a dashboard page on the GUI. And the switcher application 154 can present a ribbon of UI elements in a ribbon menu on the GUI to allow scrolling between different UI elements and switching between corresponding applications.

The video game controller 120 is an example of an input device. The video game controller 120 may allow the user 122 to interact with one or more GUIs presented by the video game consol 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content (e.g., illustrated as a car race video game content) on the display 130. Upon user input from the video game controller 120 (e.g., a user push of a particular key or button), the rendering process also presents the menu 112. Additionally, or alternatively, the menu 112 may be presented as an initial landing page in response to a user powering-on the video game console 110 and/or waking the video game consol 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the menu application 150. Upon receiving a user input from the video game controller 120 requesting interactions with the menu 112, an underlying application (e.g., the menu application 150, the dashboard application 152, or the switcher application 154 as applicable) supports such interactions by updating the menu 112 and launching any relevant application in the background or foreground. The video game player 122 can exit the menu 112 or automatically dismiss the menu 112 upon the launching of an application in the background or foreground. Upon exiting the menu 112 or the dismissal based on a background application launch, the user control changes from the underlying application to the video game application 140.

As described in more detail below, the dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple column element with textual or graphical description in each column, and the like. As described further, below, widgets may be presented with application information and/or dynamic content presented with the widget in a media library. For example, the dashboard application 152 may generate and/or present widgets associated with media applications, system applications and/or services, video game applications, or the like.

As described in more detail below, the dashboard application 152 may be executed via multiple avenues of ingress. For example, the dashboard application 152 may be executed by a pre-defined user interaction (e.g., via controller 120, a voice command from the video game player 122, activating and/or powering-on the video game consol 110 etc.) and/or by navigating one or more menus and/or sub-menus of the video game console 110 (e.g., menu 112).

In general, the switcher application 154 may facilitate selection of a first subset of tiles to present in an immediate selection area of a library interface, as described in more detail below. The switcher application 154 may populate the first subset of tiles with tiles associated with system applications, video game applications, other forms of content, etc.

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

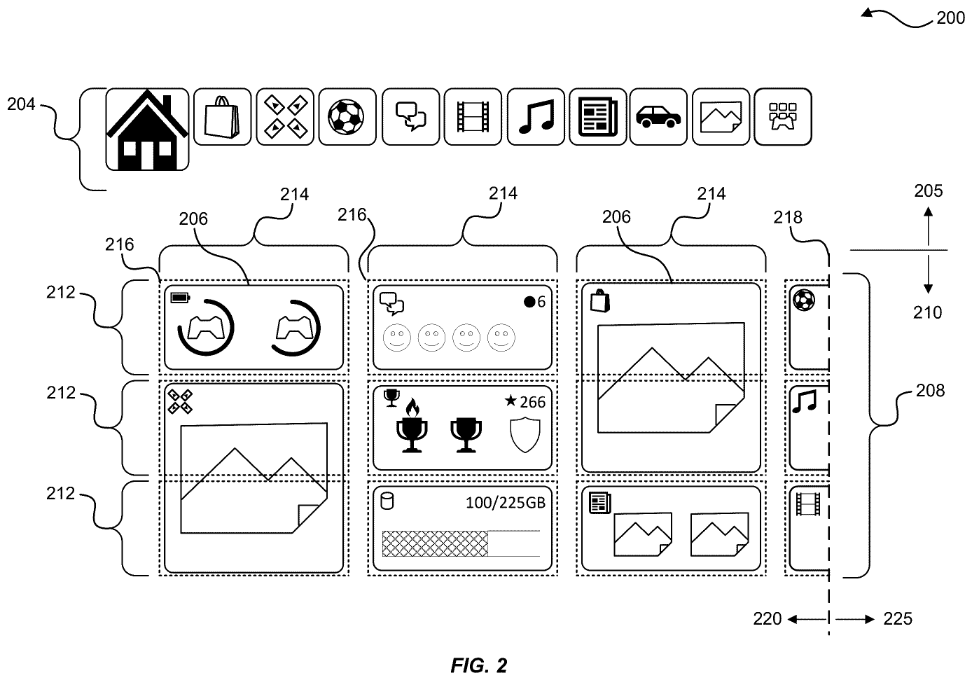

FIG. 2 illustrates an example of a menu interface 200 with an immediate selection area 205 and a dashboard area 210, according to embodiments of the present disclosure. As described above, the menu interface 200 is generated and/or presented by one or more system applications, or a combination of more than one system application. For example, a switcher application (e.g., switcher application 154 of FIG. 1) may generate and/or present the immediate selection area 205. Additionally and/or alternatively, a dashboard application (e.g., dashboard application 152 of FIG. 1) may generate and/or present the dashboard area 210. In some embodiments, a single application generates the menu interface 200. FIG. 2 illustrates the menu interface 200 provided on a video game console, but alternative and/or additional embodiments include different computer systems including, but not limited to, those described above.

As shown in FIG. 2, the menu interface 200 is a user interface (UI) that includes one or more types of UI elements. As illustrated, the menu interface 200 includes tiles 204 in the immediate selection area 205. The tiles 204 may be associated with an application and/or service available to the user of a video game console (e.g., video game player 122 of FIG. 1) generating and/or presenting the menu interface 200. As illustrated in FIG. 2, the tiles 204 may have a uniform presentation including a uniform size and regular spacing in the menu interface 200. Additionally, or alternatively, user interaction may be facilitated by one of the tiles 204 with which the user is interacting being emphasized. For example, the menu interface 200 may present a given tile with a larger or different size, or with different highlighting, to emphasize that the user selection will launch the application or service associated with the given tile.

As further illustrated, the menu interface 200 includes widgets 206 in the dashboard area 210. The widgets 206 may be associated with various applications and/or services available to the user of a video game console. As described herein, a widget may be an interactive UI element that displays content from an application and/or service available to the user of the video game console. For example, widgets may show system status information, such as battery levels for one or more remote control devices connected to the computer system, storage usage for one or more memories or hard drives connected to and/or integrated within the computer system. As another example, widgets may display content previews from various applications, such as a poster for a new video game that a user can access, headlines from various news sources, image highlights from a user's media library, or the like. In yet another example, widgets may display summary statistics from applications, such as in-game achievement summaries, on-line friends, chat summaries, or the like.

In response to interactions with a widget, the widget may be updated to show additional information, such as a description of a new game, a recent message from a chat contact, a summary of a news article, a media browser, or the like. In some embodiments, widgets are expanded to show additional information in response to user interaction. For example, in response to a widget being selected, the widget may be expanded into an overlay window over all or a portion of the menu interface 200. Additionally, or alternatively, in response to a widget being selected, an underlying application associated with the selected widget may be launched to take control over the display. In some embodiments, widgets can display information and/or content in a carousel format. For example, a list of screenshots could be cycled through via predefined user inputs of one or more control devices. In some embodiments, the information displayed within a widget is configurable. In response to user interaction with a widget, a user may update a context of the widget to alter how and/or what the widget displays. For example, a context for a media gallery widget can be updated to switch between displays of media at random, based on the recency of the media, based on a user rating (e.g., favorite content), media associated with achievements of the user, or the like.

Examples of widgets may include an “online friends” widget that displays the avatars, names, and/or activity of friends who are currently online (e.g., logged in using their respective computer systems and device). Interactions with an “online friends” widget may include navigations within a carousel of friends. Another example may include a “storage summary” widget that displays: graphic representations of different levels of current storage in different applications on internal and external hard drives; the amount of data occupied by games, media libraries, saved data, and other applications; or the like. A “news” widget may display a singular representation of news from an application developer, the developer/manufacturer of the computer system, or the like. In response to an interaction with a “news” widget, additional information about the piece of news may be presented. A “store” application may display background art, logos, names, availability, pricing, and other information for new games and/or applications that are available for purchase by the user from an application store or marketplace, a “trophies” widget may display the total number of trophies or other accomplishments of the user, a level of the user, how close the user is to achieving a next level, and/or a breakdown of the players trophies and/or other accomplishments. A “wishlist” widget may display items (e.g., games, media content, applications, etc.) that the user has recently added to a wishlist for later purchase or download. A “battery level” widget may display graphical representations of the remaining battery life of accessory/peripheral devices (e.g., remote controls, headsets, etc) connected to the computer system, the names of the devices, or the like. A “media gallery” widget may display recent screenshots or other media saved to a media library by the user. A “friends activity” widget may display cover art or a trophy with a description of an activity completed by a friend, as well as an identification of the friend, such as the friend's avatar, name, and/or online status. A “messages” widget may display recent messages sent/received by the user to/from one or more friends. In response to interaction with a “messages” widget, a user may be able to type and send a message to a friend, view a history of messages, and/or switch between different conversations. An “accessibility” widget may display a cover image and, in response to interaction with the widget, may provide a user with access to one or more settings to improve the usability and/or accessibility of the functionalities provided by the computer system. A “live broadcast” widget may display.

The menu interface 200 is broadly separated into two areas, the immediate selection area 205 and the dashboard area 210. As described above, the immediate selection area 205 provides streamlined access to a subset of recently accessed and/or obtained applications and/or services from a full library of applications and/or services available to the user of the computer system. As further described below, the dashboard area 210 provides streamlined access to a collection of information from multiple applications and/or services that is most likely to be of interest to the user based on their preferences and/or current context. Users may thereby find information and updates from across the many applications and services available on the computer system without navigating to each individual application and/or service. In addition to providing an improvement to the operation of the video game console, the menu interface 200 may also provide an improved user experience, at least in part by permitting the user of the video game console to spend relatively less time selecting an application from amongst the available applications, and/or switching seamlessly between applications.

In some embodiments, the dashboard area 210 has a predefined display structure. For example, and as illustrated, the dashboard area 210 may have a tabular structure 208 defined by a number of rows 212 and columns 214, with each cell 216 corresponding to a display position for all or a portion of a widget. The predefined display structure of the dashboard area 210 may be larger than the total display area of the menu interface 200. For example, and as further illustrated, the tabular structure 208 may extend beyond an edge 218 of the menu interface 200. Depending on the size of the menu interface 200, the predefined display structure may be separated into a first portion 220 that is immediately visible upon displaying the dashboard area 210 and a second portion 225 that is initially hidden. In response to one or more user interactions, such as a user scrolling to the right within dashboard area 210, widgets in the second portion 225 may come into view from the right edge of the menu interface 200 while widgets in the first portion 220 at the left edge of the menu interface 200 go out of view. In some embodiments, the predefined display structure of the dashboard area 210 may be expandable to accommodate additional or fewer widgets. For example, as additional widgets are added to the dashboard area 210, additional columns and/or rows may be added to tabular structure 208 to create additional display positions for the additional widgets.

Widgets may occupy one or more display positions within the predefined display structure of the dashboard area 210. For example, and as illustrated, widgets may occupy two or more adjacent display positions within a column of tabular structure 208. Additionally, or alternatively, widgets may occupy two or more adjacent display positions in a row of tabular structure 208. In some embodiments, widgets may occupy display positions within two or more columns and/or rows. For example, widgets may occupy a two-by-two or three-by-three grid of display positions within tabular structure 208.

While illustrated and described in reference to a tabular structure, additional structures and/or layouts may be used to organize the widgets 206 within dashboard area 210, such as a circular and/or carousel type structure. Additionally, or alternatively, dashboard area 210 may simply use coordinates and display sizes to achieve a more freeform presentation of widgets. For example, dashboard area 210 may define a range of coordinates within which widgets may be displayed, and each widget may then be associated with a two-dimensional range of coordinates within which the widget will be displayed. Additionally, or alternatively, while illustrated and described in reference to rectangular widgets, additional shapes and/or sizes of widgets may be used, such as circular, square, ovoid, or the like.

As described above, widgets may correspond to various application and/or services available to a user of a computer system. Each widget may be provided as an interface to the underlying application and/or service. Additionally, or alternatively, a system application, such as the dashboard application 152, may define an interface through which the applications and/or services may provide the intended content for display within a widget.

The display of widgets within the dashboard area 210 may be in accordance with one or more templates. A template may define a selection of the available widgets that should be included in the dashboard area 210, their order of display (e.g., their associated display positions), the theme of the widgets (e.g., color, contrast, shading, shape, font, text size, icon appearances, etc.), as well as their presentation state (e.g., how many display positions will be occupied, and in what orientation). As described further below, templates may be predefined based on the interests of broad groups of users and/or custom made for an individual user. Based on the interests of a group of users, and/or an individual user, templates may be defined so that the most relevant widgets, and their associated underlying information, are immediately available or otherwise visible within the first portion 220 of the dashboard area 210. By defining templates that arrange the most relevant widgets within the first portion 220, additional system navigation, whether within dashboard area 210 or to individual applications and/or services, may be reduced, thereby minimizing unnecessary resource consumption by the computer system from launching underlying applications, as well as increasing user productivity and satisfaction.

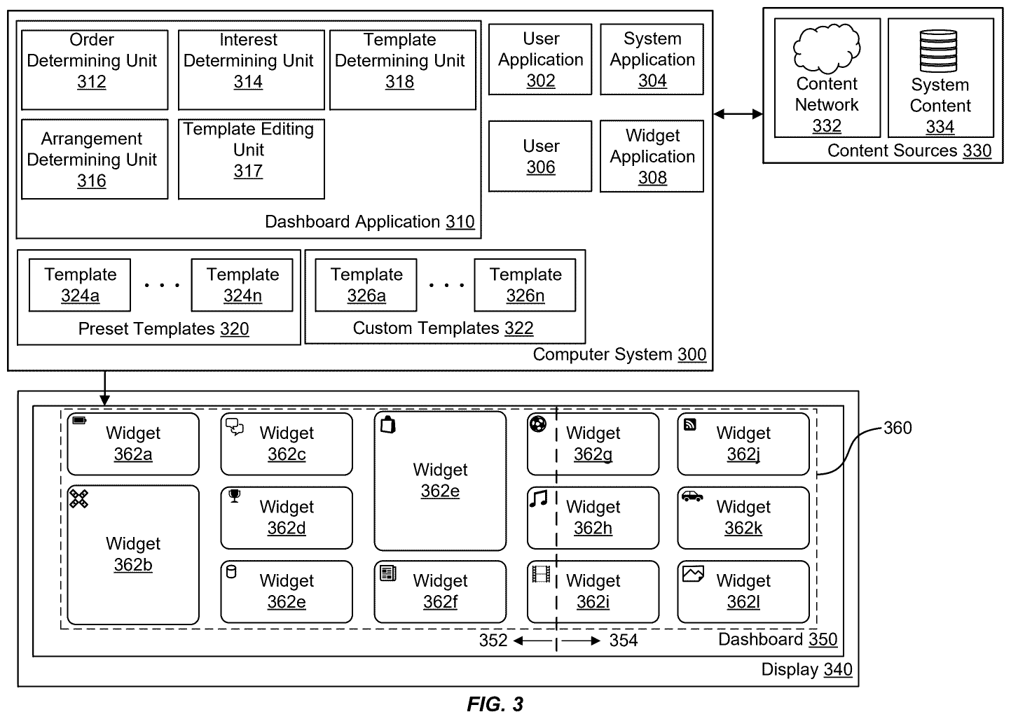

FIG. 3 illustrates an example of a computer system 300 that presents a dashboard 350 populated with widgets, according to embodiments of the present disclosure. As illustrated in FIG. 3, the computer system 300 includes a dashboard application 310. The dashboard application 310 may be the same, or function in a similar manner as the dashboard application 152 described in relation to FIG. 1. The dashboard application 310 may include an order determining unit 312, an interest determining unit 314, a template determining unit 318, an arrangement determining unit 316, and a template editing unit 317. These are described as sub elements of the dashboard application 310, but may also be different applications of the computer system 300, providing data to the dashboard application 310 for the dashboard application 310 to perform operations. The dashboard application 310 may determine templates for displaying widgets 362a-1 in the dashboard 350.

As described above, the widgets 362a-1 may be interactive UI widgets that display information and/or content from applications executing on, or other otherwise available for execution on, the computer system 300, such as user application 302 and system application 304. System application 304 may correspond to one or more native applications and/or services provided by the operating system of the computer system 300. For example, system application 304 may monitor the connection status and/or battery status of one or more peripheral devices, such as a wireless remote control, connected to the computer system 300. As another example, system application 304 may monitor the status of a storage system, such as one or more hard drives connected to or installed within the computer system 300. User application 302 may correspond to one or more add-on and/or third-party applications and/or services, such as one or more video game applications, media streaming applications, content marketplaces or “stores”, or the like, installed on, or otherwise accessed from, the computer system 300 by a user 306. System application 302 and/or user application 302 may obtain the content for display via their associated widgets from one or more content sources, such as content sources 330.

Content sources 330 may include a content network 332, including, but not limited to, a cloud-based content storage and/or distribution system. The content sources 330 may also include system content 334 provided by a data store communicatively coupled with the computer system (e.g., a hard drive, flash drive, local memory, external drive, optical drive, etc.).

The widgets 362a-1 may display content from system application 302 and/or user application 304 via a widget application 308. The widget application 308 may provide an interface through which the system application 302 and/or the user application 304 can display application specific information. In other words, the widget application 308 may provide one or more services that accept content from applications and present them in the form of an interactive UI widget. Additionally, or alternatively, the widget application 308 may act as a widget library and/or widget management service that provides the available widgets from the various applications and/or services of the computer system 300 to the dashboard application 310 for display according to one or more templates.

As further described above, the dashboard application 310 may select and display widgets according to one or more templates or layouts. As described herein, a template and/or widget layout may define a plurality of widgets available from the widget application 308 (e.g., from the various system and/or user applications and/or services of the computer system 300), an order of presenting the plurality of widgets within the dashboard 350, a theme applied to each of the widgets (e.g., color, contrast, icons, font, etc.), and/or the presentation states of each of the plurality of widgets within the dashboard 350. Collectively, the selection, order, and presentation states may be referred to as an arrangement 360 of widgets indicated by a template.

The dashboard application 310 may determine templates from preset templates 320 and/or custom templates 322. Preset templates 320 may include a first set of templates 324a-n, each indicating a unique arrangement of a plurality of widgets for display within the dashboard 350. Preset templates 320 may be defined by the dashboard application 310 and/or received by the computer system 300 from an external content source, such as a developer of the computer system 300. Preset templates 320 may be predefined based on common interests shared by groups of users. For example, a highlights template may be defined for users who are commonly interested in viewing content and/or information highlighting the latest content, information, and/or services that are available via the system and/or user applications of the computer system, as well as recent updates on the activities of other users (e.g., “friends”). A social preset template may be defined for users who are most interested in staying connected with a group of users (e.g., friends), available multiplayer activities, events, and/or results, or the like. A solo preset template may be defined for users are most commonly interested in information and content related to single-player gaming experiences and are otherwise less interested in social and/or activity updates from other users. These three preset templates are provided for illustrative purposes only and other and/or different number of preset templates are possible.

Custom templates 320 may include a second set of templates 326a-n created by and/or for a specific user, such as the user 306. For example, custom templates 322 may include one or more templates created as a result of the user making one or more modifications to a preset template of preset templates 320. As another example, custom templates 322 may include one or more templates created for a user based on one or more historical interactions with the computer system 300, and/or another computer system on which the user was active.

The dashboard application 310 may determine the appropriate template from the preset templates 320 and/or the custom templates 322 based on the interests of the user 306. The interest determining unit 314 may determine the interests of the user. The interests of the user 306 may be determined from one or more settings associated with a user account for the user 306. The interests of the user 306 may be determined from one or more privacy profile settings associated with the user 306. Privacy profile settings associated with the user 306, and/or a user account associated with the user 306, may be used to control who can communicate with the user 306 via the computer system 300 and/or who can see activity of the user 306 on the computer system 300. Privacy profile settings may be tied to a user account and applied to any device on which the user 306 signs in using the user account. Privacy profile settings may control who can see shared media and recent activities from games, who can send friend requests, follow activity, see other connections, see personal information about the user 306 (e.g., the user's real name), and/or communicate with the user 306. Privacy profile settings may include a social and open profile setting indicating that the user 306 is open to all requests and messages, and/or that any other user can see the profile information for the user 306. Privacy profile settings may include a team player setting indicating that any other user can see the profile information of the user 306, but that they need to be at least a friend of a friend to initiate communication with the user 306. Privacy profile settings may include a friend focused setting indicating that only friends of the user 306 can see information about the user 306 and/or invite the user 306 to chat. A solo and focused setting may indicate that no other users can see the profile information of the user 306 or invite the user 306 to chat, even if the user has added them as a friend. In some embodiments, the privacy profile setting defaults to a most restrictive setting to protect the privacy of the user 306. In some embodiments, the user account may include an indication of whether or not the user has reviewed, modified, and/or accepted the default privacy profile setting.

Additionally, or alternatively, the interests of the user 306 may be determined from one or more historical interactions by the user 306 with content on the computer system 300. The historical interactions by the user 306 may indicate a frequency and/or proportion of time spent on the computer system 300 interacting with various types of content. Depending on the type of contents with which the user 306 most frequently interacts, the interest determining unit 314 may determine the interests of the user 306. For example, historical interactions by the user 306 indicating that the user frequently interacts with social media type services and content, such as chat messages from friends, multiplayer activities and/or statistics, shared media from other users, or the like, may be used to determine that the user 306 is interested in social and/or multiplayer content. As another example, historical interactions by the user 306 indicating that the user frequently interacts with single-player games, media applications (e.g., music, video, news, etc.), personal in-game achievements and/or statistics, or the like, may be used to determine that the user 306 is interested in solo or single-player content.

In some embodiments, the interest determining unit 314 generates and/or maintains a ranking of interests for the user 306. A ranking of interests for a user may indicate the relative level of interest in each type of content that the user may have at any given and/or at a particular point in time. The ranking of interests may be based on the relative frequency with which the user 306 interacts with each type of content corresponding to an identifiable interest. For example, if the user 306 interacts with social media type applications and/or content more frequently than single-player content, the ranking of interests may be generated with a social media interest ranked higher than a single-player interest.

The order determining unit 312 may determine an order of presenting widgets within a template based on the interests of the user 306 (e.g., as determined by interest determining unit 314). In some embodiments, widgets are associated with a specific interest indicating that the type of content displayed by the widget corresponds to the specific interest. Based on the type of content displayed by each widget, order determining unit 312 may determine an order of presenting the widgets that aligns with the interests of the user 306. For example, order determining unit 312 may create a ranking of widgets that corresponds to the ranking of interests from the interest determining unit 314, with widgets corresponding to the highest ranked interest being placed earlier in the order of presentation than widgets corresponding to lower ranked interests.

The arrangement determining unit 316 may determine the arrangement of presenting widgets within a template. As described above, the arrangement of presenting widgets within a template may indicate the individual display position for each widget and/or the presentation state for each widget. As described above, the display position for a widget may correspond to a location, position, slot, or other identifiable place or position within a predefined dashboard structure, such as a tabular structure. As further described above, the presentation state may include the size of the widget within the arrangement and/or the number of display positions that the widget will occupy within a predefined dashboard structure. The arrangement may adhere to a predefined order of presenting the widgets (e.g., as determined by the order determining unit 312). For example, widgets identified earlier in the order may be assigned an earlier display position within a predefined dashboard structure or layout while widgets identified later in the order are assigned a later display position within the predefined dashboard structure. In some embodiments, the arrangement is determined based on the size of a first portion 352 of the dashboard 350 that will be immediately visible upon displaying the dashboard 350 on the display 340. For example, arrangement determining unit 316 may set the display position and/or presentation state of a subset of widgets to maximize the number of widgets in a first part of the order (e.g., corresponding to a highest ranked interest) that will be displayed within the first portion 352, with lower ranked and/or ordered widgets being added to the arrangement in display positions and/or presentation states that will result in their being in a second portion 354 of the dashboard 350. In some embodiments, the arrangement determining unit 316 further determines the arrangement of presenting widgets within a template based on one or more accessibility settings. For example, one or more settings may cause the arrangement determining unit 316 to adjust all widgets within a predefined order to their largest size to improve widget visibility.

The template editing unit 317 may provide one or more sets of functionalities that allow the user 306 to create and/or modify custom templates, such as custom templates 322. For example, the template editing unit 317 may enable the user 306 to add and remove widgets from a preset template. The template editing unit 317 may enable the user 306 to rearrange the widgets within an arrangement indicated by a preset template, such as by changing the display position associated with one or more widgets and/or by modifying the presentation state of one or more widgets. For example, the template editing unit 317 may provide an accessibility toggle that allows the user to automatically increase the size of each widget within a template to its largest size. The template editing unit 316 may save the modifications made to a preset template as a custom template. Upon subsequent modifications by the user 306 to the custom template, the template editing unit 317 may update the arrangement indicated by the custom template and/or create a new custom template. For example, in response to the user 306 making modifications to the custom template, the template editing unit 317 may provide the user 306 with options to update the custom template to reflect the new modifications or save the modifications as a new custom template.

In some embodiments, the custom templates 322 include a single custom template that is updated to reflect any changes to a current template being used to display widgets in the dashboard. For example, after making modifications to a preset template, the template editing unit 317 may create a custom template to reflect the modified arrangement. Subsequently, upon additional modifications to the arrangement indicated by the custom template, the template editing unit 317 may update the custom template to reflect the modifications. In response to the user 306 requesting the same, or a different preset template, the dashboard 350 may be updated to present the widgets according to the requested preset template. In response to subsequent modifications to the requested preset template, the template editing unit 317 may replace the arrangement in the custom template with the new arrangement according to the modifications to the requested preset template.

The template determining unit 318 may determine the template for displaying the widgets in the dashboard 350. The template determining unit 318 may determine the template by selecting a template from a plurality of templates, such as preset templates 320 and/or custom templates 322. The template determining unit 318 may select a template based on the identified interests of the user 306 (e.g., from interest determining unit 314). The template determining unit 318 may select a template from preset templates 320 that corresponds to a privacy profile setting. For example, the template determining unit 318 may select a highlights template from preset templates 320 in response to interest determining unit 314 determining that the user 306 has not made a selection of a privacy profile setting, has not confirmed a default privacy profile setting assigned to the user 306 upon creating a user account, and/or is otherwise interested in viewing highlights from across the range of applications and/or services available on the computer system 300. As another example, the template determining unit 318 may select a solo template from preset templates 320 in response to the interest determining unit 314 determining that the user 306 has selected a solo and focused privacy profile setting and/or that the user is otherwise more likely to be interested in viewing content related to solo activities. In yet another example, the template determining unit 318 may select a social template from preset templates 320 in response to the interest determining unit 314 determining that the user 306 has selected a friend focused, a team player, and/or a social and open privacy profile setting, and/or that the user is otherwise more likely to be interested in viewing content related to activities performed by and/or with other users.

The template determining unit 318 may determine the template for displaying the widgets in the dashboard 350 by generating one or more templates. The template determining unit 318 may generate one or more templates based on interests common to groups of users, as described above. Additionally, or alternatively, the template determining unit 318 may generate one or more custom templates for a particular user, such as the user 306. The template determining unit 318 may generate the one or more custom templates for a particular user based on the interests of the user (e.g., as determined by the interest determining unit 314). The template determining unit 318 may select a subset of widgets (e.g., from the widget application 308) based on the interests of the particular user. Additionally, or alternatively, the template determining unit 318 may receive a selection of the subset of widgets, or a selection of a subset of widget categories from the user. The template determining unit 318 may provide the subset of widgets and/or the interests of the user to the order determining unit 312 and/or the arrangement determining unit 316 to generate the arrangement of the subset of widgets according to an order that aligns with the interests of the user. The template determining unit 318 may then store the arrangement in association with a new custom template for the user.

The template determining unit 318 may select a template from the preset templates 320 and/or custom templates 322 based on one or more interactions by the user 306. For example, the template determining unit 318 may select a particular template in response to a request from the user 306 for that particular template. In some embodiments, the template determining unit 318 selects the template based on the most recently selected and/or modified template. The template determining unit 318 may use the same template for displaying widgets in the dashboard 350 until the user 306 requests a different template for display and/or modifies the arrangement indicated by the current template. Additionally, or alternatively, the template determining unit 317 may dynamically select templates for display based on the current interests of the user 306 (e.g., as determined by the interest determining unit 314).

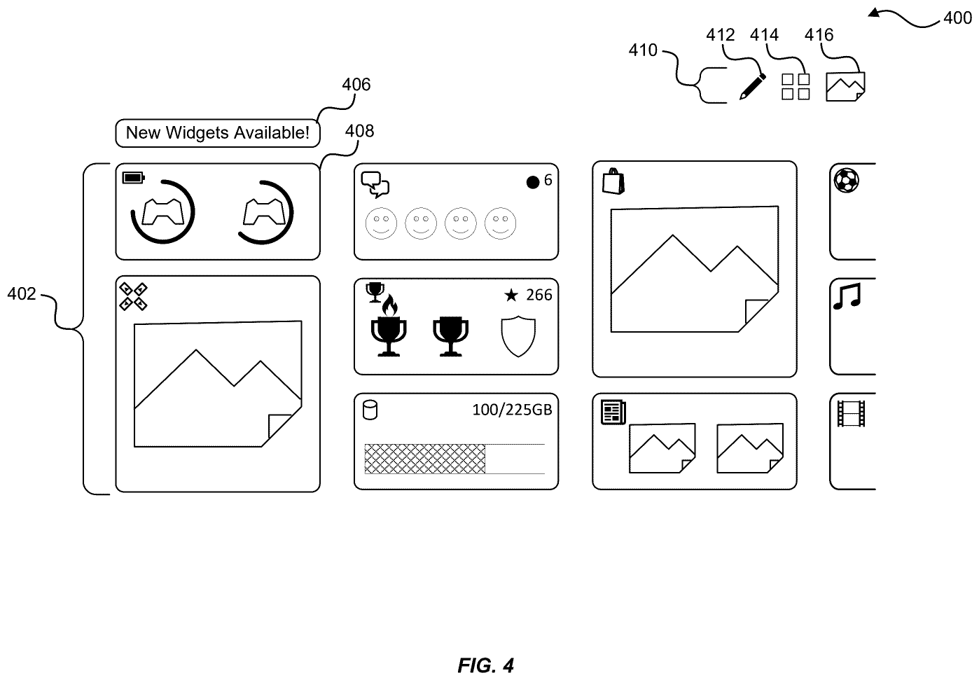

FIG. 4 illustrates an example of a dashboard interface 400, according to embodiments of the present disclosure. As illustrated, the dashboard interface 400 includes an arrangement 402 of interactive UI widgets. As described above, the arrangement 402 may be indicated by a template determined based on one or more settings associated with a user account of a user, one or more interests of the user, or the like.

As further illustrated, the dashboard interface 400 includes a temporary widget 406. As described herein, a temporary widget, or “transient widget,” may be a system widget that appears briefly to provide time-sensitive, contextual information or options to a user. The placement of the temporary widget 406 within the dashboard interface may be selected so as not to interfere with the placement of other widgets while still capturing the attention of the user. For example, and as illustrated, the temporary widget 406 may be displayed adjacent to (e.g., above or to the side) of a first widget 408 in the arrangement 402. Temporary widgets may be removed from the dashboard interface after their purpose has been accomplished. For example, the temporary widget 406 may no longer be displayed within the dashboard interface 400 in response to the user interacting with the temporary widget 406. Additionally, or alternatively, temporary widgets may be removed after a predetermined amount of time and/or after a predetermined number of presentations within the dashboard interface. For example, the temporary widget 406 may be removed after the dashboard interface 400 has been displayed to the user with the temporary widget 406 on four, five, ten, or another suitable number of different occasions. Compared to notifications, temporary widgets may be embedded into the dashboard interface 400 rather than presented as an overlay window over the dashboard interface 400.

As further illustrated, the dashboard interface 400 includes a dashboard utilities menu 410. The dashboard utilities menu may provide one or more options for editing the contents and display of the dashboard interface 400, such as a template editing option 412, a template selection option 414, and a background editor option 416. As described further below, the template editing option 412 may surface one or more controls that enable the user to edit the selection, arrangement, and/or presentation states of widgets within the dashboard interface 400. Likewise, the template selection option 414 may surface one or more controls that enable the user to switch between one or more preset templates of displaying the widgets in the dashboard interface 400.

The background editor option 416 may surface one or more controls that enable the user to edit the background image over which the widgets are displayed. In some embodiments, the background editor option 416 launches a background selection page. The background selection page may allow a user to choose a background for the dashboard interface 400 from still and/or dynamic images generated by one or more developers, such as the developer of the computer system and/or one or more application developers. Additionally, or alternatively, the background selection page may allow a user to choose a background image from the user's own media library, which may include images saved by the user on the computer system, images uploaded to the computer system, or the like.

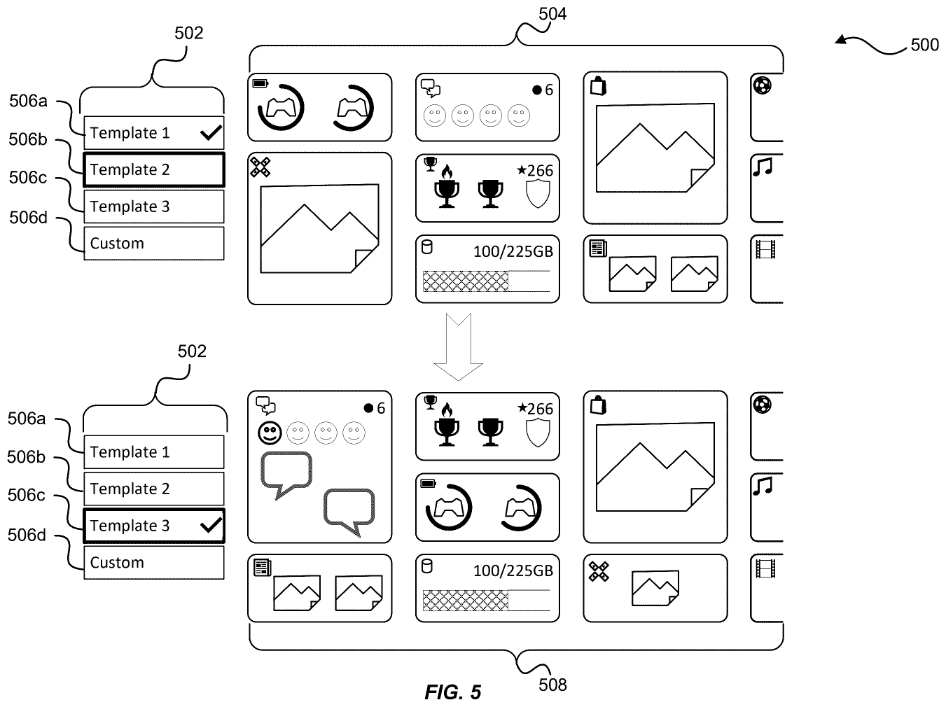

FIG. 5 illustrates an example of a dashboard interface 500 in response to an interaction with a dashboard template menu 502, according to embodiments of the present disclosure. The dashboard interface 500 may be presented in response to a user interaction with a template selection option, such as template selection option 414 described above. Compared to the dashboard interface 400 of FIG. 4, the dashboard interface 500 has been updated to include the dashboard template menu 502 adjacent to an arrangement 504 of widgets. Updating the dashboard interface 500 to include the dashboard template menu 502 may include shifting the display of the arrangement 504 of widgets within the dashboard interface 500 to make room for the display of the dashboard template menu 502. Additionally, or alternatively, updating the dashboard interface 500 to include the dashboard template menu 502 may include shrinking the size of the display of the arrangement 504 of widgets so that a same subset of widgets remain visible within the dashboard interface 500.

The dashboard template menu 502 may include a plurality of UI elements 506a-d corresponding to preset templates that are available for use in displaying the widgets in the dashboard interface 500. The dashboard template menu 502 may include a visual indicator of the active template. For example, and as illustrated, the UI element 506a may be displayed with a checkmark to indicate that “Template 1” will be used to display the widgets in the dashboard interface 500 upon dismissing the dashboard template menu 502. The dashboard template menu 502 may further include an indicator of the currently selected template. For example, and as illustrated, a border of the UI element 506b may be emphasized relative to the other UI elements to indicate that the arrangement 504 of widgets currently being displayed in the dashboard interface 500 is in accordance with “Template 2.”

In some embodiments, the arrangement of widgets within the dashboard interface 500 is updated in response to user interactions navigating between UI elements 506a-d within the dashboard template menu 502. For example, in response to a user interaction selecting UI element 506c (e.g., by scrolling down from UI element 506b), the dashboard interface 500 may be updated to display a second arrangement 508 according to the corresponding “Template 3.” Additionally, or alternatively, the dashboard interface 500 may be updated to display the second arrangement 508 in response to a further interaction setting “Template 3” as the active template, as further indicated by the checkmark in UI element 506b.

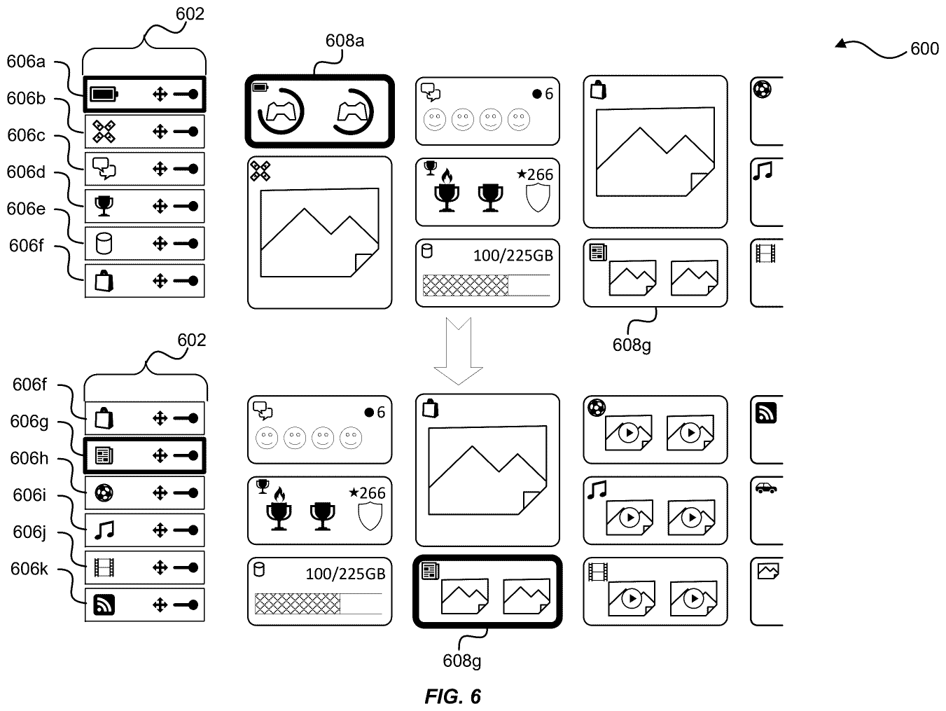

FIG. 6 illustrates an example of a dashboard interface 600 in response to an interaction with a widget menu 602, according to embodiments of the present disclosure. The dashboard interface 600 may be presented in response to a user interaction with a template editing option, such as the template editing option 412 described above. Compared to the dashboard interface 400 of FIG. 4, the dashboard interface 600 has been updated to include the widget menu 602 adjacent to an arrangement of widgets. Updating the dashboard interface 600 to include the widget menu 602 may include shifting the arrangement of widgets within the dashboard interface 600 to make room for the display of the widget menu 602. Additionally, or alternatively, updating the dashboard interface 600 to include the widget menu 602 may include shrinking the display size of the arrangement of widgets so that a same subset of widgets remains visible within the dashboard interface 600. While the arrangement of widgets may be shifted and/or resized to allow for the display of the widget menu 602, the contents of each widget may remain the same. In this way, the user can see a live preview of the arrangement of widgets as they edit the template.

The widget menu 602 may include a plurality of UI elements 606a-k. Each of the plurality of UI elements 606a-k may correspond to one of the widgets 608. For example, and as illustrated, the UI element 606a may correspond to the widget 608a and the UI element 606g may correspond to the widget 608g. In some embodiments, the UI elements 606a-k are displayed within the widget menu 602 in the same order of presentation as their corresponding widgets 608a-k. Within the widget menu 602, the UI element that is currently in focus may be emphasized relative to other UI elements in the widget menu 602. The UI element that is in focus may be a default UI element that is selected upon presenting the widget menu 602. For example, and as illustrated, the size of the borders of the first UI element in the widget menu 602 (e.g., UI element 606a) may be increased relative to the borders of the other UI elements in the widget menu 602.

The display of the widget in the dashboard interface 600 corresponding to the in-focus UI element may also be emphasized relative to other widgets displayed in the dashboard interface 600. For example, and as illustrated, the size of the borders of the widget 608a may be increased relative to the size of the borders for the other widgets within the dashboard interface 600. While illustrated and described as increasing the size of a widget's or other UI element's border, other methods of emphasizing UI elements and/or widgets may be used. For example, rather than increasing the size of the boarders for the widget 608a, the opacity of the entire widget 608a may be increased relative to the opacity of the other widgets in the dashboard interface 600 and/or the opacities of the other widgets may be decreased relative to the opacity of widget 608a. Additionally, or alternatively, widgets may be emphasized relative to other widgets by increasing the clarity of an emphasized widget relative to other widgets so that the emphasized widget appears to be in focus while the contents of other widgets appear blurred.

As the user navigates within the widget menu 602 (e.g., by moving a cursor or supplying a directional input control), the UI element that is in focus may be updated. For example, in response to a user navigating down within the widget menu 602, the UI element 606g may be emphasized to indicate that it is currently in focus. Similarly, the display of widgets within the dashboard interface 600 may be updated in response to navigations within the widget menu 602. For example, in response to the navigation within the widget menu 602 that results in the UI element 606g being in focus, the corresponding widget 608g may be emphasized. Additionally, or alternatively, the display of widgets within the dashboard interface 600 may be shifted to center the corresponding widget 608g within the visible portion of the arrangement of widgets in the dashboard interface 600.

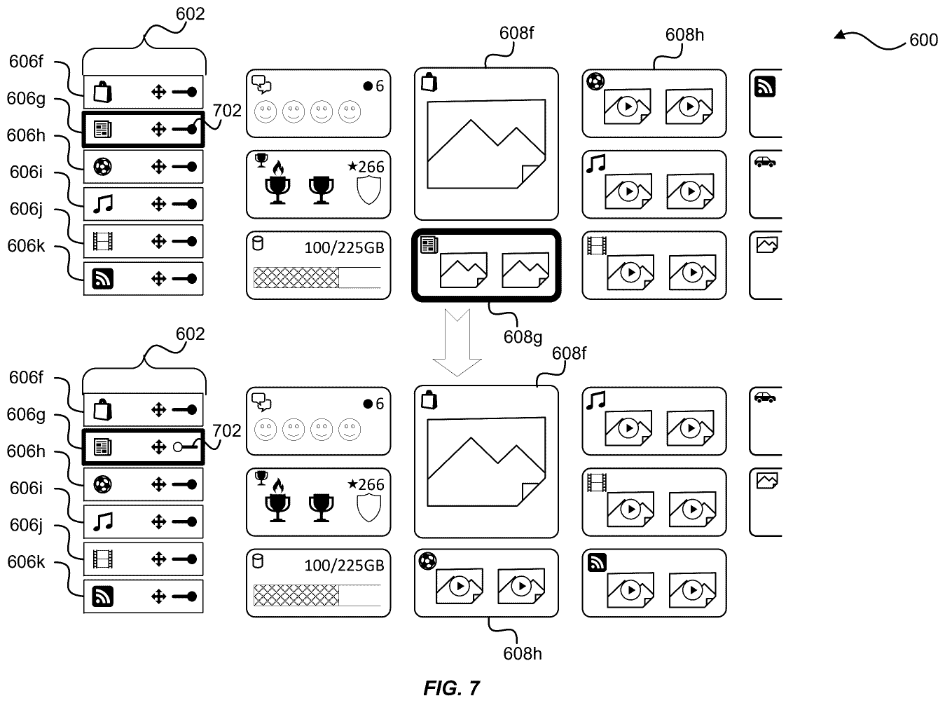

FIG. 7 illustrates an example of the dashboard interface 600 in response to an interaction with a widget visibility control, according to embodiments of the present disclosure. As illustrated in FIG. 7, each of the UI elements 606a-k in the widget menu 602 may include a visibility control slider 702. The visibility control slider 702 may allow a user to control whether the corresponding widget will be included in the widgets displayed in the dashboard interface 600. For example, and as illustrated, in response to a user interaction with the visibility control slider 702 of the UI element 606g, the corresponding widget 608g may be hidden from display within the dashboard interface 600. In response to a user removing a widget from the arrangement, the arrangement may be updated so that another widget occupies the display position of the removed widget. For example, and as illustrated, widget 608h has been moved to take the place originally occupied by the widget 608g. As another example, a widget that was previously adjacent to the removed widget (e.g., widget 608f) may be expanded in size to occupy the display position.

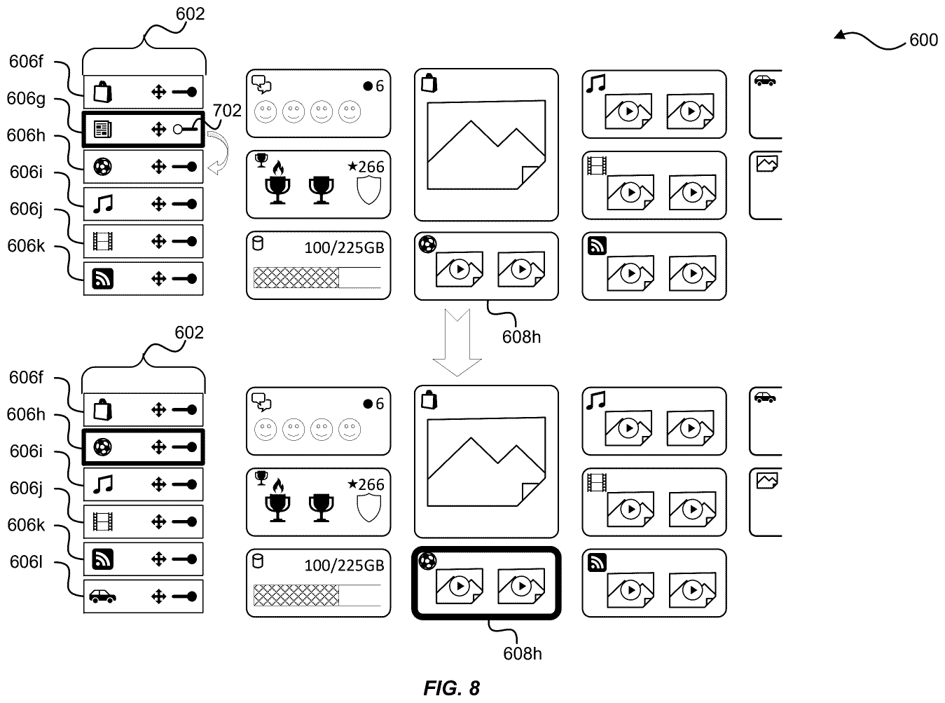

FIG. 8 illustrates another example of the dashboard interface 600 in response to an interaction with the widget menu 602, according to embodiments of the present disclosure. As illustrated in FIG. 8, while the arrangement of widgets in the dashboard interface 600 may be updated to provide the user with a preview of the arrangement after removing a widget (e.g., the widget 608g), the corresponding UI element (e.g., UI element 606g) may remain visible within the widget menu 602. In response to a subsequent navigation within the widget menu, the UI element corresponding to the removed widget may similarly be removed from the widget menu. For example, and as illustrated, in response to a user interaction navigating away from the UI element 606g to the UI element 606h, the UI element 606g may be removed from the display of the widget menu 602. As further illustrated, the corresponding widget 608h may be emphasized relative to the other widgets in response to the UI element 606h being in focus within the widget menu 602.

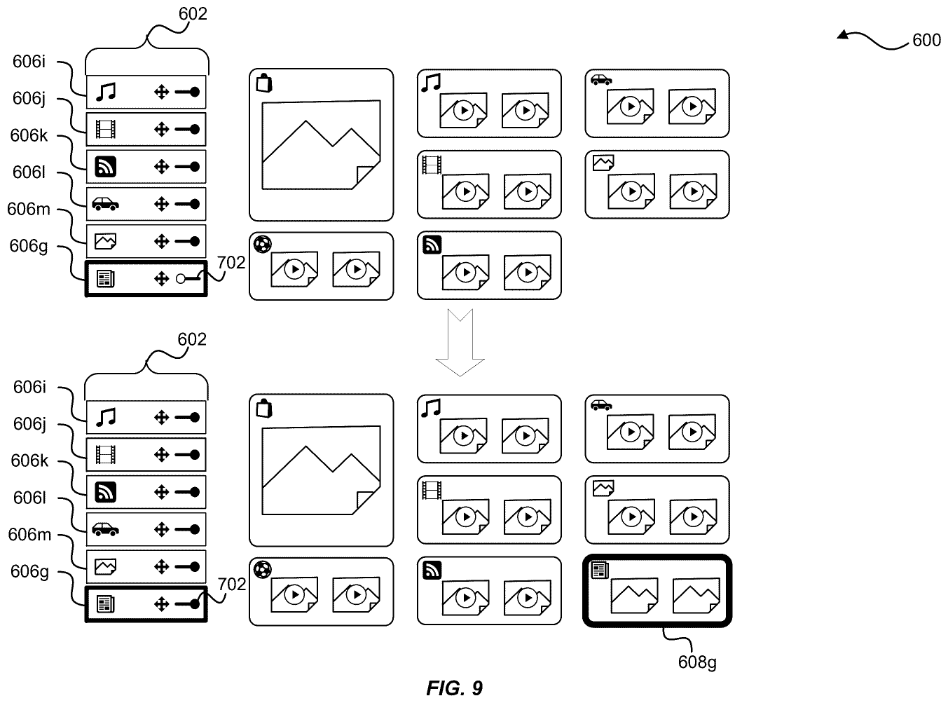

FIG. 9 illustrates another example of the dashboard interface 600 in response to an interaction with a widget visibility control, according to embodiments of the present disclosure. In some embodiments, the widget menu 602 includes UI elements corresponding to widgets that are not currently visible and/or included in the arrangement of widgets displayed within the dashboard interface. As illustrated in FIG. 9, the UI elements that correspond to the hidden widgets may be displayed at an end of the widget menu 602. For example, and as illustrated, the UI element 606g may be moved to the bottom of the widget menu 602 in response to the corresponding widget 608g being removed from the arrangement. In response to a subsequent user interaction with the visibility control slider 702 of the UI element 606 g, the arrangement of widgets displayed in the dashboard interface 600 may be updated to include the corresponding widget 608g. In some embodiments, adding a widget to the arrangement results in the widget being added at the next available display position at the end of the arrangement. Additionally, or alternatively, adding a widget that was previously removed from the arrangement may result in the widget being added to the arrangement in its previous display position prior to its removal.

While illustrated and described as being added and/or removed from the arrangement in response to an interaction with the visibility control slider 702 in the widget menu 602, other implementations are possible. For example, while a UI element in the widget menu 602 is in focus or otherwise selected as the widget to receive modifications, an interaction with a predefined button or control input of a remote control may have the same effect as toggling the slider in the UI element to add or remove the corresponding widget from the arrangement. Similarly, while the visibility control slider 702 is illustrated as a slider, other UI elements may be used to achieve a similar effect, such as a check box, a radio button, or the like.

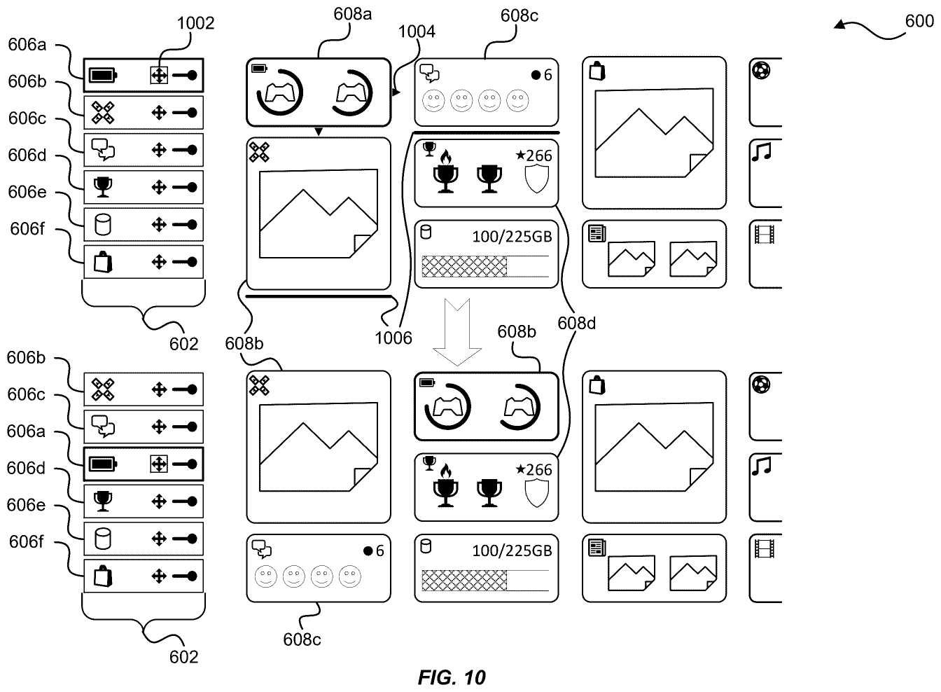

FIG. 10 illustrates an example of the dashboard interface 600 in response to an interaction with a widget relocation control, according to embodiments of the present disclosure. As illustrated in FIG. 10, each of the UI elements 606a-f in the widget menu 602 may include a relocation controller 1002. The relocation controller 1002 may allow a user to modify the display position of the corresponding widget within the arrangement displayed in the dashboard interface 600. In some embodiments, a user interaction with the relocation controller 1002 results in one or more relocation controls being displayed within the dashboard interface 600.

The one or more relocation controls may include direction indicators. For example, and as illustrated, arrows 1004 may be displayed adjacent to widget 608a in response to an interaction with the relocation controller 1002. The arrows 1004 may indicate that the possible directions in which the widget 608a may be moved are to the right and/or downward within the arrangement of widgets. The widget 608a may be relocated in relation to the other widgets in response to an a user interaction (e.g., a selection) with of one of the arrows 1004. Additionally, or alternatively, the widget 608a may be relocated in relation to the other widgets in response to the user interacting with a corresponding directional control input of a control device, such as a physical scroll wheel, joystick, and/or direction pad of a remote control device.

The one or more relocation controls may further include future position indicators to illustrate the proposed location of the widget relative to other widgets. For example, and as further illustrated, bars 1006 may be displayed within the dashboard interface to indicate that, in response to a downward input, the widget 608a will be relocated within the arrangement between the widget 608b and the widget 608c, or that, in response to an input to the right, the widget 608a will be relocated within the arrangement between the widget 608c and the widget 608d.

In response to inputs from the user relocating a widget, the arrangement of widgets displayed in the dashboard interface may be updated to display the widget in its new position. For example, and as illustrated, in response to a user input moving the widget 608a to the right within the arrangement, the widget 608b and the widget 608c may be shifted to new display positions and the widget 608a may be located in the display position previously occupied by the widget 608c. Similarly, the display of the corresponding UI element may be updated within the widget menu to reflect the new order of widgets in the arrangement. For example, and as illustrated, the UI element 606a may be displayed between the UI element 606c and the UI element 606d.

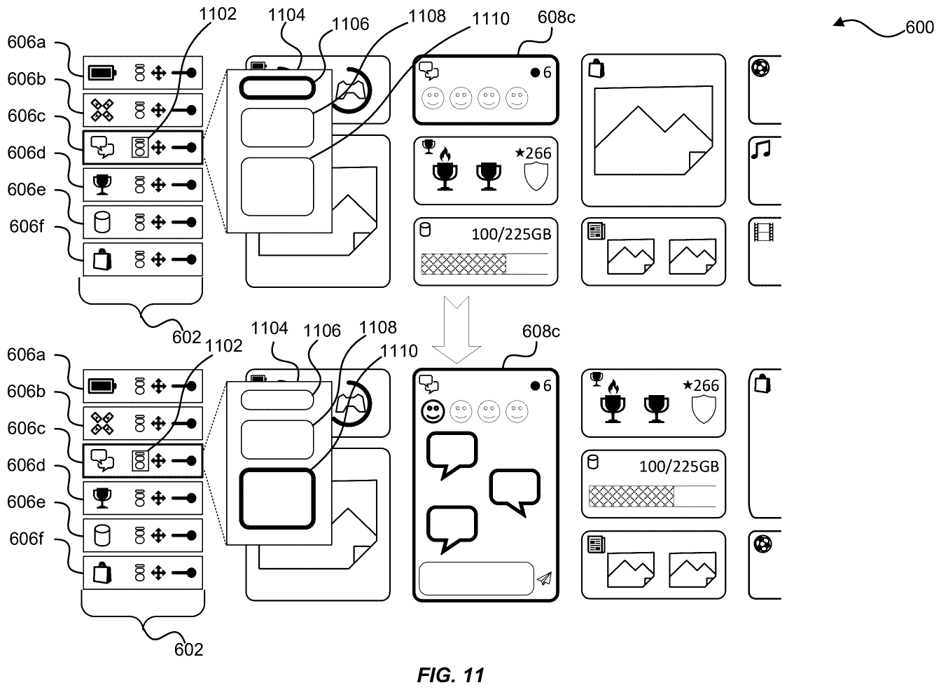

FIG. 11 illustrates an example of the dashboard interface 600 in response to an interaction with a widget presentation state control, according to embodiments of the present disclosure. As illustrated in FIG. 11, each of the UI elements 606a-f in the widget menu 602 may include a presentation state controller 1102. The presentation state controller 1102 may allow a user to modify the presentation state of the corresponding widget within the arrangement displayed in the dashboard interface 600. In some embodiments, a user interaction with the presentation state controller 1102 results in one or more presentation state controls being displayed within the dashboard interface 600.

The one or more presentation state controls may include a presentation state menu with options for choosing between one or more possible presentation states for the corresponding widget. For example, and as illustrated, an overlay window 1104 may be displayed over a portion of the arrangement of widgets in the dashboard interface 600 in response to a user interaction with the presentation state controller 1102 of the UI element 606c. The overlay window 1104 may include the possible presentation states for the widget 608c that corresponds to the UI element 606c. In this example, the presentation states may include a small presentation state 1106, a medium presentation state 1108, and a large presentation state 1110. As illustrated, the small presentation state 1106 corresponds to a widget size that takes up a single display position within the arrangement of widgets, the medium presentation state 1108 corresponds to a widget size that takes up two display positions in a column, and the large presentation state 1110 corresponds to a widget size that takes up three display positions in a column.

While illustrated and described as representing different display sizes, and/or numbers of display positions in a same column for the corresponding widget, additional and/or alternative types of presentation states may be possible. For example, different presentation states may be defined for various widget shapes, such as circular widgets, oval widgets, square widgets, or the like. As another example, different presentation states may be defined for various combinations of sizes and orientations, such as a horizontal widget that takes up multiple display positions within a same row, a vertical widget that takes up multiple display positions within a same column, and/or a rectangular widget that takes up multiple display positions across multiple rows and columns.

In some embodiments, the presentation state menu includes a visual indicator of the currently selected and/or active presentation state for the corresponding widget. For example, and as illustrated, the small presentation state 1106 may be emphasized within the overlay window 1104 to indicate that the widget 608c is currently being displayed in the small presentation state. In response to navigation within the presentation state menu, the display of the corresponding widget in the dashboard interface may be updated to preview visual effect of the presentation state that is currently in focus in the menu. For example, and as illustrated, in response to navigation within the overlay window 1105 from the small presentation state 1106 to the large presentation state 1110, the dashboard interface 600 may be updated to present the widget 608c in the corresponding presentation state that occupies three display positions in the same column.

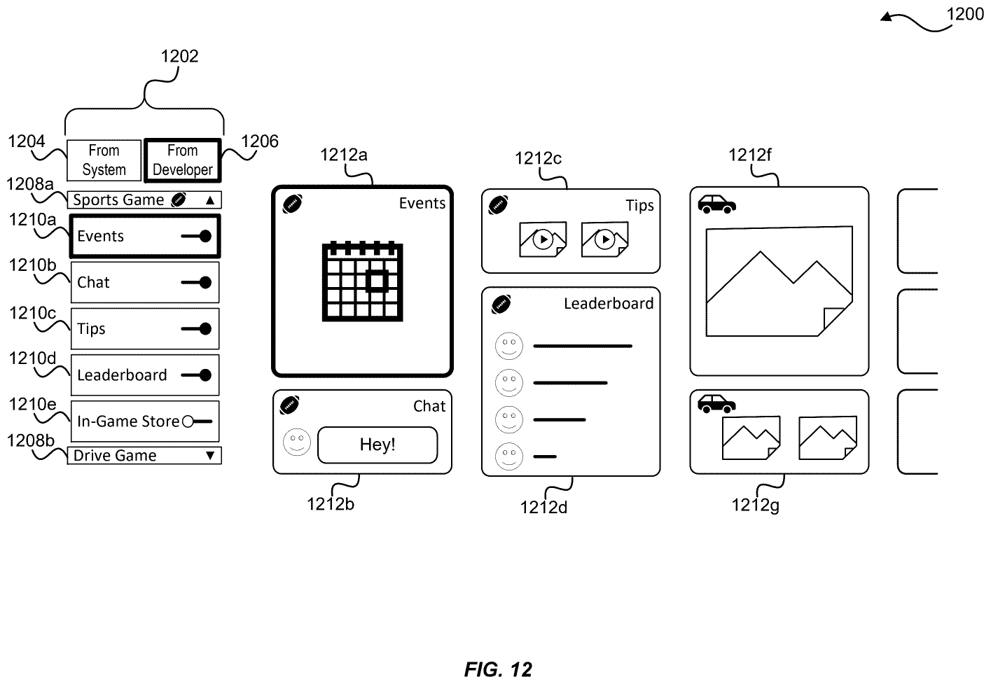

FIG. 12 illustrates another example of a dashboard interface 1200 with an application specific widget menu, according to embodiments of the present disclosure. The dashboard interface 1200 may be presented in response to a user interaction with a template editing option, such as the template editing option 412 described above. As further described in relation to FIG. 6, the dashboard interface 1200 includes a widget menu 1202. Compared to the widget menu 602 of FIG. 6, the widget menu 1202 may include multiple tabs corresponding to different categories of widgets. For example, and as illustrated, the widget menu 1202 includes a system widget tab 1204 and a developer widget tab 1206. Selecting the system widget tab 1204 may result in the widget menu 1202 being populated with UI elements corresponding to applications and/or services provided by the computer system, such as the UI elements illustrated in the widget menu 602 of FIGS. 6-11.

Selecting the developer widget tab 1206 may populate the widget menu 1202 with UI elements corresponding to after-market and/or third-party applications and/or services that may be installed or otherwise accessible to the computer system. For example, and as illustrated, the widget menu 1202 includes a first UI element 1208a corresponding to a “Sports Game” application and a second UI element 1208b corresponding to a “Drive Game” application. In some embodiments, the UI elements 1208 are drop-down elements. In response to an interaction with a drop-down element associated with a particular application, the widget menu 1202 may be populated with widget control elements representing application widgets provided by the particular application. In response to an interaction with the first UI element 1208a, the widget menu 1202 may be populated with widget elements 1210a-d that correspond to different widgets provided by the “Sports Game” application. Additionally, or alternatively, the UI elements 1208 may be non-interactive elements used to visually separate and identify widget elements associated with one application from widget elements associated with another application. As described herein, application widgets may function in the same or similar manner as system widgets, in that they may present content and other information. However, compared to system widgets, application widgets may be configured by and/or populated by a third-party application.

As further described in reference to FIG. 6, the widget element in the widget menu 1202 that is currently in-focus, and its corresponding widget, may be emphasized relative to other widget elements and their corresponding widgets. For example, and as illustrated, in response to one or more user interactions and/or navigations within the widget menu 1202 resulting in the widget element 1210a being in focus, the corresponding widget 1212a may be emphasized relative to the other widgets 1212b-g. The order, arrangement, selection, and presentation states of application widgets may be modified in the same or similar ways as described above in reference to FIGS. 7-11. For example, application widgets may be added and/or removed from the arrangement of widgets, relocated to different locations within the arrangement, or the like.

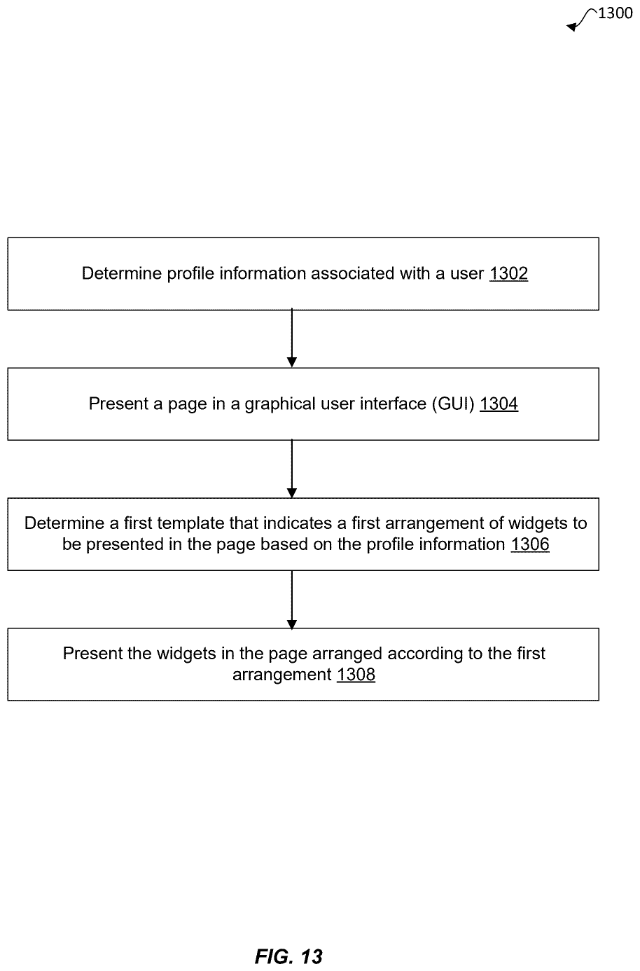

FIG. 13 illustrates an example flow 1300 for presenting widgets in a page, according to embodiments of the present disclosure. The operations of the flow 1300 can be implemented as hardware circuitry and/or stored as computer-readable instructions on a non-transitory computer-readable medium of a computer system, such as a video game system. As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations may be omitted, skipped, and/or reordered.

In an example, the flow includes operation 1302, where the computer system determines profile information associated with a user of the computer system. The profile information may include one or more interests of the user. The one or more interests of the user may be determined from one or more account settings for an account associated with the user. For example, and as described above, the one or more account settings may include privacy profile settings. The one or more interests of the user may be determined from historical interactions by the user. The historical interactions by the user may include previous interactions with content related to each of the one or more interests. The historical interactions by the user may be interactions on the computer system, and/or another computer system on which the user has accessed content while logged in on the same user account. In some embodiments, the profile information comprises a geographic location associated with the computer system.

In an example, the flow includes operation 1304, where the computer system presents a page in a GUI. The page may be a welcome page, a landing page, a menu interface (e.g., the menu interface 200), a dashboard interface (e.g., the dashboard interface 400, the dashboard interface 600, and/or the dashboard interface 1200), or a similar visual interface capable of being rendered on a display connected to the computer system. The page may include a first portion that is immediately visible upon presenting the page (e.g., the first portion 220) and a second portion that becomes visible in response to navigation inputs within the page (e.g., the second portion 225). The page may include a plurality of display positions in a structured layout. For example, and as described above, the page may define a tabular structure with a predefined number of columns and/or rows. Each of the plurality of display positions may have a uniform size within the structured layout.

In an example, the flow includes an operation 1306, where the computer system determines a first template that indicates a first arrangement of widgets based on the profile information. As described above, widgets may be customizable and/or modular UI elements that offer control over content display based on individual interests. The first template may be one of a plurality of templates. The first arrangement of widgets may be different from that of other templates of the plurality of templates. Each template of the plurality of templates may indicate a different arrangement of a plurality of widgets. An arrangement may define a display position and a presentation state within the structured layout of the page for each of the plurality of widget identified by the arrangement. The display position and the presentation state for a widget may define a starting display position within the structured layout and an area (e.g., a number of display positions) occupied by the widget within the structure layout. The plurality of widgets identified by the arrangement may include all or a subset of widgets provided by or otherwise available on the computer system.

Determining the first template may include determining that a subset of the widgets that will be presented in the first portion of the page are relevant to the profile information associated with the user. Determining the first template may include selecting the first template from the plurality of templates based on a relevance of the first template to the profile information associated with the user. For example, based on profile information indicating that the user is interested in social activities and content, the first template may be selected based on its arrangement being designed to appeal to users who are interested in social activities and content. Arrangements may be designed to appeal to particular interests by including widgets related to those interests early within the arrangement and/or in a more prominent presentation state.

In some embodiments, determining the first template includes generating a custom template and/or arrangement based on the profile information associated with the user. Generating a custom arrangement may include determining a relevance of each available widget from the computer system to the profile information associated with the user. Based on the relevance of each widget, an order of presenting the widgets within the page may be determined. For example, each widget may be assigned a relevance score. The widgets may then be ranked according to their relevance score. The ranking of widgets may then be used as the order of presenting the widgets within the page.

In some embodiments, determining the first template includes determining a display position and a presentation state (e.g., a display size) for each widget in the arrangement. The display position and presentation state of a subset of the widgets may be selected based on the size of the first portion of the page that will be immediately visible. For example, the display positions and presentation states for a subset of the widgets that are determined to be most relevant to the profile information may be selected so that the subset of the widgets will fit within the first portion of the page and/or fully occupy the first portion of the page.

In some embodiments, each arrangement of the plurality of templates includes all of the widgets available from the computer system. In such cases, each arrangement may differ in the display order of the widgets and/or in the presentation states of the widgets. In some embodiments, each arrangement of the plurality of templates includes a different subset of the widgets available from the computer system. For example, each different subset of the widgets may be selected for inclusion in an arrangement based on those widgets being associated with and/or otherwise relevant to the profile information of the user. In some embodiments, determining the first template includes determining the geographic location of the computer system. Different templates may be defined for different geographic regions (e.g., countries). Templates defined for different geographic regions may include different subsets of widgets. For example, some widgets that do not comply with local laws and/or regulations may be restricted from inclusion in templates defined for certain geographic regions.

In an example, the flow includes an operation 1308, where the computer system presents the widgets in the page arranged according to the first arrangement. Presenting the widgets according to the first arrangement may include presenting the widgets in an order determined by the first arrangement. Presenting the widgets according to the first arrangement may include presenting the widgets in the display positions and presentation states defined by the first arrangement.

In an example, the flow 1300 may further include an operation where the computer system receives a request to review the plurality of templates. For example, the page may include a UI element where, in response to a selection of the UI element, the computer system presents a template menu comprising the plurality of templates. The template menu may include an indication that the first template is currently selected and/or that the widgets in the page are being presented according to the arrangement indicated by the first template. The template menu may be presented while the widgets remain visible in the page. In response to an interaction with a second template in the template menu, the page may be updated to present the widgets according to a second arrangement indicated by the second template. The updates to the page may occur while the template menu remains visible. Concurrently displaying the template menu and the widgets may reduce unnecessary processing associated with additional navigation and rendering requests by allowing the user to view a live preview of the widgets according to a different template before dismissing the template menu.

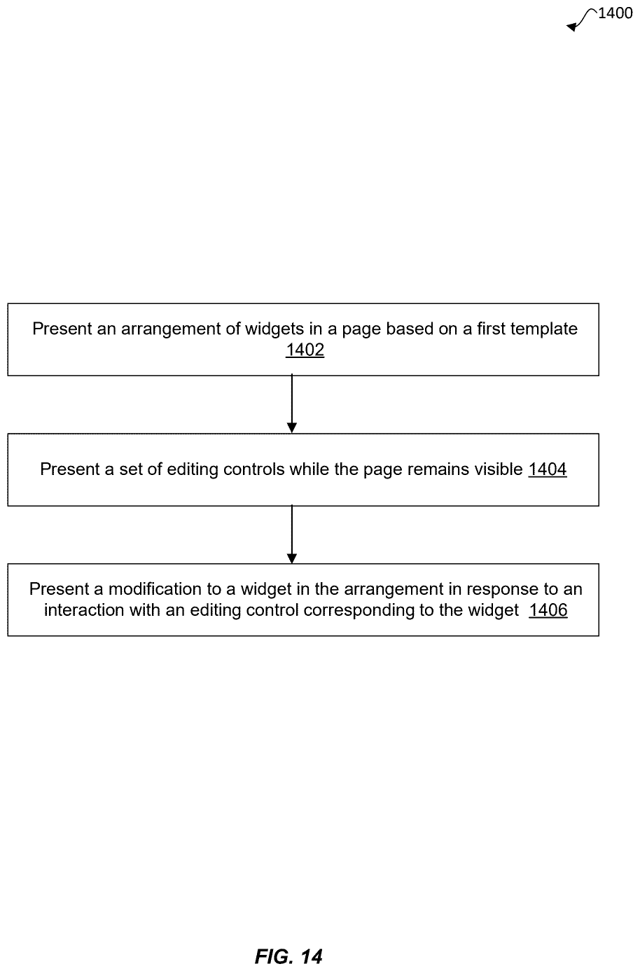

In an example, the flow 1300 may further include an operation where the computer system receives a modification to the first arrangement, resulting in a new arrangement of widgets within the page. As described in further reference to FIG. 14, the page may include a UI element where, in response to a selection of the UI element, the computer system provides one or more controls for modifying the first arrangement, such as by adding or removing a widget from the arrangement, moving a widget to a new display position within the arrangement, and/or modifying the presentation state of a widget. The one or more controls may be displayed, accessed, and/or activated concurrently with the display of the widgets within the page. Likewise, the modifications to the widgets in the page may be displayed concurrently with the display of the controls. By concurrently displaying the controls, the widgets, and the modifications, the computer system may reduce excess processing associated with the user navigating between a separate control pages and the resulting changes to the display of widgets.

In an example, the flow 1300 may further include an operation where the computer system creates a new template with the modified arrangement of widgets. Once created, the new template may be stored as a custom template with the plurality of preset templates. In some embodiments, the computer system allows the user to save subsequent modifications as a new custom template or to replace the existing arrangement of the custom template with the subsequent modifications. Additionally, or alternatively, a single custom template may be used to record the most recent modifications to any template. For example, after initially creating a custom template, the user may make subsequent modifications to the arrangement of widgets indicated by custom template, and the resulting modifications may be stored in the same custom template, effectively replacing the initial arrangement indicated by the custom template. As another example, the user may return the first or another preset template and make modifications to the corresponding arrangement, which modifications may then be stored in the custom template.

In an example, the flow 1300 may further include an operation where the computer system receives a notification comprising information about a new computing service available to the computer system. The new computing service may include a new widget available for addition to the page, new tips or guides for interacting with the computing system, new applications available for installation, or the like. Additionally, or alternatively, the notification may comprise information about existing computing services, such as the status of a download or upload, the status of a subscription, the status of an application trial, or other time-sensitive and/or contextual information or options that are relevant to the user's current context and/or interactions with the computer system. In response, the computer system may display a temporary widget in the page. The temporary widget may be displayed at a beginning of the arrangement, such as in a first display position within the arrangement. Additionally, or alternatively, the temporary widget may be displayed in a dedicated display position outside of the arrangement of widgets (e.g., without affecting the existing display of widgets within the page). The temporary widget may include the information about the new computing service and/or contextual information. The temporary widget may be removed from the page once the purpose of its display has been achieved and/or is no longer relevant. For example, the temporary widget may be removed in response to an interaction with the temporary widget that results in additional information about the new computing service being displayed to the user. As another example, the temporary widget may be removed upon completion of a download or installation of an application for which the temporary widget was displaying the status.

FIG. 14 illustrates an example flow 1400 for editing an arrangement of widgets in a dashboard, according to embodiments of the present disclosure. The operations of the flow can be implemented as hardware circuitry and/or stored as computer-readable instructions on a non-transitory computer-readable medium of a computer system, such as a video game system. As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations may be omitted, skipped, and/or reordered. The example flow in FIG. 14 can be performed in conjunction with or separately from the example flow in FIG. 13.

In an example, the flow 1400 includes an operation 1402, where the computer system presents an arrangement of widgets in a page based on a first template. The arrangement of widgets in the page according to the first template may be presented as described above in reference to FIG. 13. As further described above, the page may include UI elements that allow the user to edit the arrangement of widgets.

In an example, the flow 1400 includes an operation 1404, where the computer system presents a set of editing controls while the arrangement of widgets in the page remains visible. As described above, the set of editing controls may be presented in response to a request to edit the arrangement of widgets (e.g., via an interaction with a UI element in the page). The set of editing controls may be presented as a widget editing menu. For example, and as described above in relation to widget menu 602, the widget editing menu may include a set of editing controls each corresponding to a widget in the arrangement and/or otherwise available for addition to the arrangement. Each editing control may include one or more selectable options for modifying a display of the corresponding widget. For example, each editing control may include a visibility option that controls whether the corresponding widget is included or excluded from the arrangement. As another example, each editing control may include one or more options that allow the user to modify the presentation state of the corresponding widget and/or move the corresponding widget to a different location or position within the arrangement.

In some embodiments, each editing control includes an indication of the corresponding widget, and/or the underlying application and/or service associated with the corresponding widget. For example, each editing control may include text identifying the name of the corresponding widget. As another example, each editing control may include an icon associated with the corresponding widget.

In some embodiments, the set of editing controls are presented according to a same order as the order in which the widgets are displayed in the arrangement. Editing controls corresponding to widgets that are not included in the arrangement may be displayed at the end of the order of editing controls that correspond to visible widgets in the arrangement. In response to a widget being removed from the arrangement, the set of editing controls may be updated so that the corresponding editing control is displayed at the end of the set of editing controls.

In an example, the flow 1400 includes an operation 1406, where the computer system presents a modification to a widget in the arrangement in response to an interaction with an editing control corresponding to the widget. The presentation of the modification may be performed while the page continues to be presented. As described above, the interaction with the editing control may include a selection of an option to remove the widget from the arrangement and presenting the modification may include removing the widget from the page. Presenting the modification may further include shifting a subset of the widgets that were lower in the order into a higher display position. As another example, the interaction with the editing control may include a selection of an option to add the widget to the arrangement and presenting the modification may include adding the widget to an end of the arrangement of widgets. Additionally, or alternatively, presenting the modification may include adding the widget to a position within the arrangement that was previously occupied by the widget before it was removed. In response, the widget at that position, as well as widgets in lower positions, may be shifted to accommodate the display of the widget at that position. In yet another example, the interaction may include a selection of an option to move the widget to a new position and presenting the modification may include displaying the widget at the new position and shifting a subset of the widgets that are lower in the display order into later display positions. In another example, the interaction may include a selection of an option to resize the first widget, and presenting the modification may include increasing or decreasing a display size of the widget within the arrangement.

In some embodiments, interactions with editing controls include navigations from one editing control to the another. In response to navigations from one editing control to another, the display of widgets in the page may be updated. For example, as the focus changes from one editing control to another, the widget corresponding to the editing control that is currently in focus may be emphasized within the page. Emphasizing a particular widget may include increasing the display opacity of the particular widget relative to the other widgets displayed in the page and/or decreasing the display opacity of the other widgets relative to the display opacity of the particular widget. Additionally, or alternatively, emphasizing a particular widget may cause the widget to be displayed in greater focus compared to the other widgets displayed in the page. In some embodiments, navigating from one editing control to another further causes the display of the arrangement of widgets to be shifted within the page. The arrangement may be shifted within the page to center the widget corresponding to the selected editing control within the page.

In an example, the flow 1400 may further include an operation where the computer system creates a new template with the arrangement of widgets as modified by the user. Once created, the arrangement in the new template may be updated in response to each subsequent modification. Additionally, or alternatively, the arrangement in the new template may be updated in response to a user interaction requesting that the current arrangement of widgets displayed in the page be saved to the new template.

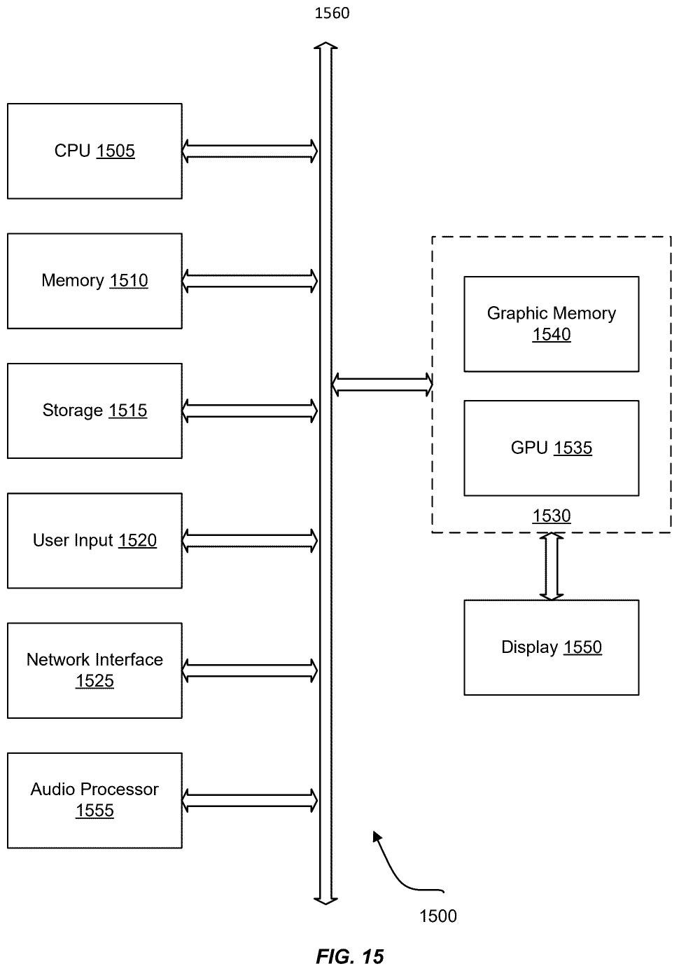

FIG. 15 illustrates an example of a hardware system suitable for implementing a computer system, according to embodiments of the present disclosure. The computer system 1500 represents, for example, a video game system, a backend set of servers, or other types of a computer system. The computer system 1500 includes a central processing unit (CPU) 1505 for running software applications and optionally an operating system. The CPU 1505 may be made up of one or more homogeneous or heterogeneous processing cores. Memory 1510 stores applications and data for use by the CPU 1505. Storage 1515 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 1520 communicate user inputs from one or more users to the computer system 1500, examples of which may include keyboards, mice, joysticks, touch pads, touch screens, still or video cameras, and/or microphones. Network interface 1525 allows the computer system 1500 to communicate with other computer systems via an electronic communications network, and may include wired or wireless communication over local area networks and wide area networks such as the Internet. An audio processor 1555 is adapted to generate analog or digital audio output from instructions and/or data provided by the CPU 1505, memory 1510, and/or storage 1515. The components of computer system 1500, including the CPU 1505, memory 1510, data storage 1515, user input devices 1520, network interface 1525, and audio processor 1555 are connected via one or more data buses 1560.

A graphics subsystem 1530 is further connected with the data bus 1560 and the components of the computer system 1500. The graphics subsystem 1530 includes a graphics processing unit (GPU) 1535 and graphics memory 1540. The graphics memory 1540 includes a display memory (e.g., a frame buffer) used for storing pixel data for each pixel of an output image. The graphics memory 1540 can be integrated in the same device as the GPU 1535, connected as a separate device with the GPU 1535, and/or implemented within the memory 1510. Pixel data can be provided to the graphics memory 1540 directly from the CPU 1505. Alternatively, the CPU 1505 provides the GPU 1535 with data and/or instructions defining the desired output images, from which the GPU 1535 generates the pixel data of one or more output images. The data and/or instructions defining the desired output images can be stored in the memory 1510 and/or graphics memory 1540. In an embodiment, the GPU 1535 includes 3D rendering capabilities for generating pixel data for output images from instructions and data defining the geometry, lighting, shading, texturing, motion, and/or camera parameters for a scene. The GPU 1535 can further include one or more programmable execution units capable of executing shader programs.

The graphics subsystem 1530 periodically outputs pixel data for an image from the graphics memory 1540 to be displayed on the display device 1550. The display device 1550 can be any device capable of displaying visual information in response to a signal from the computer system 1500, including CRT, LCD, plasma, and OLED displays. The computer system 1500 can provide the display device 1550 with an analog or digital signal.

In accordance with various embodiments, the CPU 1505 is one or more general-purpose microprocessors having one or more processing cores. Further embodiments can be implemented using one or more CPUs 1505 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 76%, 135%, 90%, 100%, 105%, 109%, 109.9% or, depending on the context within which the term substantially appears, value otherwise as known in the art.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method implemented by a computer system and comprising:
determining profile information associated with a user of the computer system;
presenting a page in a graphical user interface (GUI);
determining, based on the profile information, a first template that indicates a first arrangement of interactive GUI widgets to be presented in the page, the first arrangement being different from that of a second template of a plurality of templates, each indicating an arrangement of a plurality of interactive GUI widgets; and
presenting, based on the first template, the interactive GUI widgets in the page arranged according to the first arrangement.

2. The method of claim 1, wherein the profile information comprises one or more interests of the user determined from one or more account settings for an account associated with the user.

3. The method of claim 1, wherein the profile information associated comprises one or more interests of the user determined from historical interactions by the user with content related to each of the one or more interests.

4. The method of claim 1, wherein:
the page comprises a first portion that is immediately visible upon presenting the page and a second portion that becomes visible in response to navigation inputs; and
determining the first template comprises determining that a subset of the interactive GUI widgets that will be presented in the first portion based on the first arrangement are relevant to the profile information associated with the user.

5. The method of claim 1, wherein:
the page comprises a plurality of display positions in a structured layout; and
the first arrangement defines a display position and a presentation state within the structured layout for each of the interactive GUI widgets.

6. The method of claim 5, wherein:
each of the plurality of display positions has a uniform size within the structured layout; and
the display position and the presentation state for an interactive GUI widget defines a starting display position within the structured layout and a number of display positions occupied by the interactive GUI widget within the structured layout.

7. The method of claim 1, wherein determining the first template comprises:
selecting the first template from the plurality of templates based on a relevance of the first template to the profile information associated with the user.

8. The method of claim 1, wherein:
determining the first template comprises:
determining a relevance of each of the interactive GUI widgets to the profile information associated with the user; and
determining, based on the relevance of each of the interactive GUI widgets, an order of presenting the interactive GUI widgets within the page; and
presenting the interactive GUI widgets according to the first arrangement comprises:
presenting the interactive GUI widgets in the determined order.

9. The method of claim 8, wherein the page comprises a first portion that is immediately visible upon presenting the page, and determining the first template further comprises:
determining a display position and a display size for each of a subset of the interactive GUI widgets that will be displayed in the first portion of the page based on a size of the first portion.

10. The method of claim 1, wherein:
the interactive GUI widgets indicated by the first arrangement include a first subset of the plurality of interactive GUI widgets, the first subset being different from that of the second template.

11. The method of claim 1, wherein:
the interactive GUI widgets indicated by the first arrangement are the same as that of the second template; and
a first order of presenting the interactive GUI widgets according to the first arrangement is different from that of the second template.

12. The method of claim 1, wherein:
the interactive GUI widgets indicated by the first arrangement are the same as that of the second template; and
a size of presenting at least one of the interactive GUI widgets according to the first arrangement is different from that of the second template.

13. The method of claim 1, further comprising:
receiving a request to review the plurality of templates;
presenting, while the interactive GUI widgets remain visible in the page, a template menu comprising the first template, the plurality of templates, and an indication that the first template is currently selected;
receiving, via the template menu, an interaction with the second template; and
presenting, while the template menu remains visible, the interactive GUI widgets in the page according to a second arrangement of the second template.

14. The method of claim 1, wherein:
the profile information comprises a geographic location associated with the computer system; and
determining the first template is further based on the geographic location.

15. The method of claim 1, further comprising:
receiving, via the GUI, a modification to the first arrangement indicated by the first template, resulting in a new arrangement of the interactive GUI widgets within the page;
creating a new template with the new arrangement based on the modification; and
storing the new template as a custom template with the plurality of templates.

16. The method of claim 15, further comprising:
receiving, via the GUI, a subsequent modification to the new arrangement, resulting in a further modified arrangement; and
updating the new template with the further modified arrangement in response to receiving the subsequent modification.

17. The method of claim 15, further comprising:
receiving, via the GUI, a request to present the interactive GUI widgets in the page according to a different arrangement of a different template of the plurality of templates;
presenting the interactive GUI widgets in the page arranged according to the different template;
receiving, via the GUI, a subsequent modification to the different arrangement, resulting in a subsequent arrangement; and
updating the new template with the subsequent arrangement in response to receiving the subsequent modification.

18. The method of claim 1, further comprising:
receiving a notification comprising information about a new computing service available to the computer system;
displaying a temporary interactive GUI widget at a beginning of the first arrangement in the page, the temporary interactive GUI widget including the information about the new computing service; and
removing, in response to an interaction with the temporary interactive GUI widget, the temporary interactive GUI widget from the first arrangement.

19. A computer system comprising:
one or more processors; and
one or more memories storing computer-readable instructions that, upon execution by the one or more processors, configure the computer system to:
determine profile information associated with a user of the computer system;
present a page in a graphical user interface (GUI);
determine, based on the profile information, a first template that indicates a first arrangement of interactive GUI widgets to be presented in the page, the first arrangement being different from that of a second template of a plurality of templates, each indicating an arrangement of a plurality of interactive GUI widgets; and
present, based on the first template, the interactive GUI widgets in the page arranged according to the first arrangement.

20. One or more non-transitory computer-readable media storing computer-readable instructions that, upon execution on a computer system, cause the computer system to perform operations comprising:
determining profile information associated with a user of the computer system;
presenting a page in a graphical user interface (GUI);
determining, based on the profile information, a first template that indicates a first arrangement of interactive GUI widgets to be presented in the page, the first arrangement being different from that of a second template of a plurality of templates, each indicating an arrangement of a plurality of interactive GUI widgets; and
presenting, based on the first template, the interactive GUI widgets in the page arranged according to the first arrangement.
